(19) United States
(12) Patent Application Publication
(10) Pub. No.: US 2024/0063890 A1
(43) Pub. Date: Feb. 22, 2024

(54) METHOD AND APPARATUS FOR CONTROLLING AND CONFIGURING AMPLIFYING GAIN OF NETWORK-CONTROLLED REPEATER IN WIRELESS COMMUNICATION SYSTEM

(71) Applicant: Samsung Electronics Co., Ltd., Gyeonggi-do (KR)

(72) Inventors: Kyunggyu LEE, Gyeonggi-do (KR); Yeongeun LIM, Gyeonggi-do (KR); Hyoungju JI, Gyeonggi-do (KR)

(21) Appl. No.: 18/449,271

(22) Filed: Aug. 14, 2023

(30) Foreign Application Priority Data
Aug. 12, 2022 (KR) 10-2022-0101428

(51) Int. Cl. H04B 7/155

(52) U.S. Cl. CPC H04B 7/15535; H04B 7/15507

(57) ABSTRACT

The disclosure relates to a fifth generation (5G) or sixth generation (6G) communication system for supporting higher data transmission rates. The disclosure provides an operation and an apparatus for controlling an amplifying gain of a network-controlled repeater (NCR). A method of the NCR repeater includes receiving, from a base station (BS), configuration information on an amplifying gain for the NCR, identifying the amplifying gain based on the configuration information, amplify signals received from a terminal and the BS based on the identified amplifying gain, and transmitting the amplified signals.

### CROSS-REFERENCE TO RELATED APPLICATION(S)

This application is based on and claims priority under 35 U.S.C. § 119 to Korean Patent Application No. 10-2022-0101428, filed on Aug. 12, 2022, in the Korean Intellectual Property Office, the disclosure of which is incorporated herein by reference in its entirety.

### BACKGROUND

### 1. Field

The disclosure relates generally to a wireless communication system and, more particularly, to a method and an apparatus for controlling and configuring an amplifying gain for a network-controlled repeater in a wireless communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as mmWave including 28 GHz and 39 GHz. In addition, implementation of sixth generation (6G) mobile communication technologies (referred to as “beyond 5G systems”) in terahertz (THz) bands such as 95 GHz to 3 THz bands has been considered to achieve transmission rates fifty times faster than 5G mobile communication technologies and ultra-low latencies one-tenth of 5G mobile communication technologies.

Since the outset of 5G mobile communication technology development, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in millimeter wave (mmWave), supporting numerologies such as operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (NR UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (RACH) for simplifying RA procedures. There also has been ongoing standardization in system architecture/service regarding a 5G service based architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Accordingly, the present disclosure provides embodiments that are designed to address at least the problems and/or disadvantages described above and to provide at least the advantages described below.

An aspect of the disclosure is to provide an apparatus and a method for performing an operation of controlling an amplifying gain for a network-controlled repeater by a BS through control signaling in a wireless communication system.

An aspect of the disclosure is to provide a method and a network-controlled repeater that is able to control the amplifying gain under the control of a BS in a communication system, thereby reducing interference to the system and increasing the sensitivity and accuracy of a target signal.

In accordance with an aspect of the present disclosure, a method performed by a network-controlled repeater (NCR) in a communication system includes receiving, from a BS, configuration information on an amplifying gain for the NCR, identifying the amplifying gain based on the configuration information, amplifying signals received from a terminal and the BS based on the identified amplifying gain, and transmitting the amplified signals.

In accordance with another aspect of the present disclosure, a method performed by a BS in a communication system includes transmitting, to an NCR, configuration information on an amplifying gain for the NCR, wherein the amplifying gain is based on the configuration information, and wherein amplified signals from the NCR are based on the amplifying gain.

In accordance with another aspect of the present disclosure, an NCR in a communication system includes a transceiver, and a controller coupled with the transceiver and configured to receive, from a BS, configuration information on an amplifying gain for the NCR, identify the amplifying gain based on the configuration information, amplify signals received from a terminal and the BS based on the identified amplifying gain, and transmit the amplified signals.

In accordance with another aspect of the present disclosure, a BS in a communication system includes a transceiver, and a controller coupled with the transceiver and configured to transmit, to an NCR, configuration information on an amplifying gain for the NCR, wherein the amplifying gain is based on the configuration information, and wherein amplified signals from the NCR are based on the amplifying gain.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a transmission structure of a time-frequency domain in an NR or a wireless communication system similar thereto;

FIG. 2 illustrates a frame, a subframe, and a slot structure in a 5G;

FIG. 3 illustrates an example of configuration a BWP in a wireless communication system according to an embodiment;

FIG. 4 illustrates a downlink control channel in a wireless communication system according to an embodiment;

FIG. 5 illustrates an example of frequency-domain resource allocation (FD-RA) of a physical downlink shared channel (PDSCH) in a wireless communication system according to an embodiment;

FIG. 6 illustrates an example of time-domain resource allocation of a PDSCH in a wireless communication system according to an embodiment;

FIG. 7 illustrates an example of time-domain resource allocation of a PDSCH in a wireless communication system according to an embodiment;

FIG. 8 illustrates a method for configuring a semi-static hybrid automatic repeat request acknowledgement (HARQ-ACK) codebook in an NR system according to an embodiment;

FIG. 9 illustrates a method for configuring a dynamic HARQ-ACK codebook in an NR system according to an embodiment;

FIG. 10 illustrates an example of transmission and reception associated with an NCR when the NCR performs relaying between a BS and a UE according to an embodiment;

FIG. 11 illustrates an example of an uplink transmission according to a radio frequency ®F chain when an NCR performs relaying between a BS and a UE according to an embodiment;

FIG. 12 illustrates an amplifying gain for an NCR on a time axis according to an embodiment;

FIG. 13 illustrates a method for controlling the amplifying gain for an NCR according to an embodiment;

FIG. 14 illustrates a method for controlling the amplifying gain for an NCR by a BS according to an embodiment;

FIG. 15 illustrates a UE in a wireless communication system according to an embodiment;

FIG. 16 illustrates a BS in a wireless communication system according to an embodiment; and

FIG. 17 is a block diagram illustrating an NCR in a wireless communication system according to an embodiment.

### DETAILED DESCRIPTION

Hereinafter, embodiments of the disclosure will be described in detail with reference to the accompanying drawings.

In describing the embodiments, descriptions related to technical contents well-known in the relevant art and not associated directly with the disclosure will be omitted for the sake of clarity and conciseness.

In the accompanying drawings, some elements may be exaggerated, omitted, or schematically illustrated, the size of each element does not completely reflect the actual size, and identical or corresponding elements are provided with identical reference numerals.

In the drawings, the order of the description does not always correspond to the order in which steps of each method are performed, and the order relationship between the steps may be changed or the steps may be performed in parallel. In addition, some elements may be omitted and only some elements may be included therein or may be implemented in combination without departing from the essential spirit and scope of the disclosure.

Methods using separate tables or information including at least one element included in the tables disclosed herein, are also possible.

Throughout the specification, the same or like reference numerals designate the same or like elements.

As used herein, a “unit” refers to a software element or a hardware element, such as a field programmable gate array (FPGA) or an application specific integrated circuit (ASIC), which performs a predetermined function. However, the unit does not always have a meaning limited to software or hardware and may be constructed either to be stored in an addressable storage medium or to execute one or more processors. Therefore, the unit includes software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units or may be implemented to reproduce one or more central processing units (CPUs) within a device or a security multimedia card.

The terms which will be described below are defined in consideration of the functions in the disclosure, and may be different according to users, intentions of the users, or customs. Therefore, the definitions of the terms should be made based on the contents throughout the specification. In the following description, a BS is an entity that allocates resources to terminals, and may be at least one of a gNode B, an eNode B, a Node B, a wireless access unit, a BS controller, and a node on a network. A terminal may include a UE, an MS, a cellular phone, a smartphone, a computer, or a multimedia system capable of performing communication functions. Examples of the BS and the terminal are not limited thereto. Hereinafter, technology for receiving broadcast information from a BS by a terminal will be described. The disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology.

Herein, terms referring to broadcast information control information, communication coverage, state changes (e.g., an event), terms referring to network entities, messages, device elements, and the like are illustratively used for the sake of descriptive convenience. Therefore, the disclosure is not limited by the terms as used below, and other terms referring to subjects having equivalent technical meanings may be used.

Some of terms and names defined in the 3rd generation partnership project (3GPP) long term evolution (LTE) or 3GPP new radio (NR) standards may be used herein for the sake of descriptive convenience. However, the disclosure is not limited by these terms and names, and may be applied in the same manner to systems that conform other standards.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, and ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) {or a mobile station (MS)} transmits data or control signals to a base station (BS) (eNode B), and the downlink indicates a radio link through which the base stationBS transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, The eMBB aims at providing a data rate higher than that supported by existing LTE, LTE-A, or LTE-Pro. For example, in the 5G communication system, eMBB must provide a peak data rate of 20 gigabits per second (Gbps) in the downlink and a peak data rate of 10 Gbps in the uplink for a single base stationBS. Furthermore, the 5G communication system must provide an increased user-perceived data rate to the UE, as well as the maximum data rate. In order to satisfy such requirements, there is a need in the art for an improvement in transmission/reception technologies including a further enhanced multi-input multi-output (MIMO) transmission techniques are required to be improved. In addition, the data rate required for the 5G communication system may be obtained using a frequency bandwidth more than 20 megahertz (MHz) in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the IoT. Since the IoT provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 16 years, because it is difficult to frequently replace the battery of the UE.

Lastly, the URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system requires designs to provide a transmit time interval (TTI) shorter than those of other services, and also assign a large number of resources in a frequency band in order to secure reliability of a communication link. However, the above-described mMTC, URLLC, and eMBB are merely examples of different types of services, and the types of services to which the disclosure is applied are not limited to the above examples.

The above-described services considered in the 5G communication system must be converged with each other so as to be provided based on one framework. That is, the respective services are preferably integrated into a single system and controlled and transmitted in the integrated single system, instead of being operated independently, for efficient resource management and control.

Herein, LTE, LTE-A, LTE Pro, or NR systems will be described by way of example, but the embodiments of the disclosure may also be applied to other communication systems having similar technical backgrounds or channel types. In addition, based on determinations by those skilled in the art, the embodiments of the disclosure may also be applied to other communication systems through some modifications without significantly departing from the scope of the disclosure.

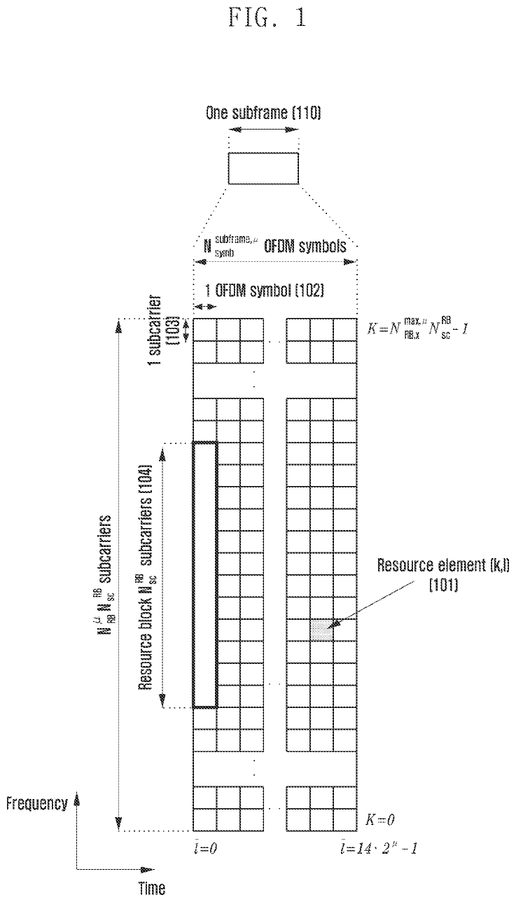

FIG. 1 illustrates the basic structure of time-frequency resources of a wireless communication system to which the disclosure is applied.

Referring to FIG. 1, the horizontal axis represents a time domain, and the vertical axis represents a frequency domain. A basic unit of resources in the time and frequency domain may be a resource element (RE) 101 defined by 1 OFDM symbol 102 in a time domain and 1 subcarrier 103 in a frequency domain. In the frequency domain, N_{SC}^{RB} (for example, 12) consecutive REs may configure one resource block (RB) 104. One subframe 110 may be configured by multiple OFDM symbols.

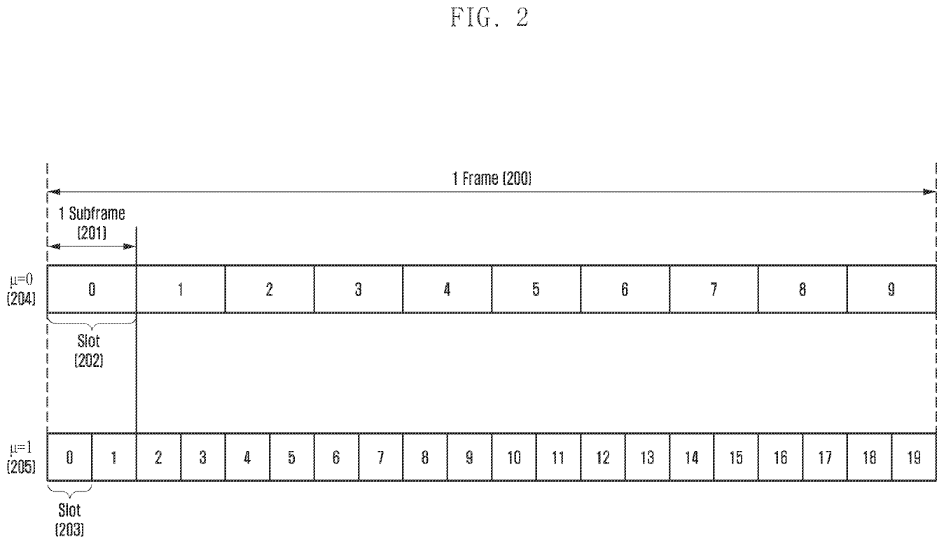

FIG. 2 illustrates a frame, a subframe, and a slot structure in a wireless communication system to which the disclosure is applied.

Referring to FIG. 2, one frame 200 may include one or more subframes 201, and one subframe may include one or more slots 202. One frame 200 may be defined as 10 ms. One subframe 201 may be defined as 1 ms and in this case, one frame 200 may be configured by a total of 10 subframes 201. One slot 202 or 203 may be defined as 14 OFDM symbols (i.e., the number of symbols for one slot (N_{symb}^{slot}=14). One subframe 201 may include one or multiple slots 202 and 203, and the number of slots 202 and 203 per one subframe 201 may differ according to configuration value μ 204 or 205 for a subcarrier spacing. FIG. 2 illustrates when the subcarrier spacing configuration value is μ=0 (indicated by reference numeral 204) and μ=1 (indicated by reference numeral 205). In a case of μ=0 (indicated by reference numeral 204), one subframe 201 may include one slot 202, and in a case of μ=1 (indicated by reference numeral 205), one subframe 201 may include two slots 203. That is, the number of slots per one subframe (Nₛₗₒₜ^{subframe, μ}) may differ according to a subcarrier spacing configuration value μ, and accordingly, the number of slots per one frame (Nₛₗₒₜ^{frame, μ}) may differ. According to each subcarrier spacing configuration μ, Nₛₗₒₜ^{subframe, μ} and Nₛₗₒₜ^{frame,μ} may be defined as shown below in Table 1.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

5G BWP

In NR, one component carrier (CC) or serving cell may be configured with up to 250 RBs. Therefore, in case that a UE always receives the entire serving cell bandwidth as in LTE, the power consumption of the UE may be extreme. In order to solve this problem, a BS can configure one or more BWPs for a UE, so as to support the UE to change the reception area within a cell.

In NR, the BS may configure an initial BWP, which is the bandwidth of CORESET #0 (or common search space (CSS)), for the UE through a master information block (MIB). Specifically, the UE before RRC connection may be configured with an initial BWP for initial access from the BS through a master information block (MIB). The UE may receive configuration information about a search space and a control resource set (CORESET) through which a PDCCH can be transmitted, in order to receive system information necessary for initial access (remaining system information (RMSI) or system information block 1 (SIB1)) through the MIB in an initial access operation. The CORESET and the search space, which are configured as MIBs, may be regarded as identity (ID) 0, respectively.

The BS may notify the UE of configuration information, such as frequency assignment information, time assignment information, and numerology for the control resource set #0 through the MIB. In addition, the BS may notify the UE of configuration information for monitoring period and occasion for the control resource set #0, that is, configuration information for the search space #0, through the MIB. The UE may regard the frequency domain configured as the control resource set #0 acquired from the MIB as the initial BWP for initial access. In this case, the ID of the initial BWP may be regarded as zero.

Thereafter, the BS may notify at least one BWP configuration information that may be indicated through downlink control information (DCI) in the future, and may indicate which band the UE uses by announcing the BWP ID through DCI. When the UE does not receive DCI in the currently allocated BWP for a specific period of time or longer, the

UE returns to a “default BWP” and attempts to receive DCI.

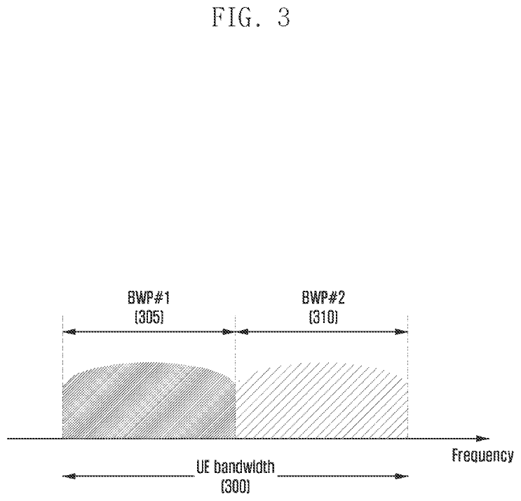

FIG. 3 illustrates an example of configuration a BWP in a wireless communication system according to an embodiment.

Referring to FIG. 3, a UE bandwidth 300 is configured by two BWPs, that is, BWP #1 305 and BWP #2 310. The BS may configure one or multiple BWPs for the UE, and may configure pieces of information as shown below in Table 2 for each BWP.

TABLE 2

| | |
|---|---|
| BWP ::= | SEQUENCE { |
| bwp-Id | BWP-Id, |
| (Bandwidth part identifier) | |
| locationAndBandwidth | INTEGER (1..65536), |
| (Bandwidth part location) | |
| subcarrierSpacing | ENUMERATED {n0, n1, n2, n3, |
| | n4, n5}, |
| (Subcarrier spacing) | |
| cyclicPrefix | ENUMERATED { extended } |
| (Cyclic prefix) | |
| } | |

The disclosure is not limited to the above example, and in addition to the configuration information, various parameters related to a BWP may be configured in the UE. The pieces of information may be transmitted by the BS to the UE via higher layer signaling radio resource control (RRC) signaling. At least one BWP among the configured one or multiple BWPs may be activated. Whether to activate the configured BWP may be semi-statically transmitted from the BS to the UE via RRC signaling or may be dynamically transmitted through a medium access control(MAC) control element (CE) or DCI.

The configuration of the BWP supported by the next generation mobile communication system (5G or NR system) may be used for various purposes.

In case that a bandwidth supported by the UE is smaller than a system bandwidth, the bandwidth supported by the UE may be supported through the BWP configuration. For example, the frequency location (configuration information 2) of the BWP is configured for the UE as shown above in Table 2 to enable the UE to transmit or receive data at a specific frequency location within the system bandwidth.

Alternatively, the BS may configure multiple BWPs in the UE for the purpose of supporting different numerologies. For example, in order to support both data transmission/reception to/from a predetermined UE by using a subcarrier spacing of 15 kHz and a subcarrier spacing of 30 kHz, two BWPs may be configured to use a subcarrier spacing of 15 kHz and a subcarrier spacing of 30 kHz, respectively. Different BWPs may be frequency division multiplexed (FDMed), and when attempting to transmit or receive data at a specific subcarrier spacing, the BWP configured with the corresponding subcarrier spacing may be activated.

Alternatively, the BS may configure, in the UE, the BWPs having bandwidths of different sizes to reduce power consumption of the UE. For example, in case that the UE supports a very large bandwidth of 100 MHz, and always transmits or receives data through the corresponding bandwidth, very high power consumption may occur. In particular, when the UE performs monitoring on unnecessary downlink control channels of a large bandwidth of 100 MHz even when there is no traffic, the monitoring may be very inefficient in terms of power consumption. Therefore, in order to reduce power consumption of the UE, the BS may configure a BWP of a relatively small BWP of 20 MHz for the UE. In a situation without traffic, the UE may perform a monitoring operation on a BWP of 20 MHz. When data occurs, the UE may transmit or receive data by using a BWP of 100 MHz according to an indication of the BS.

In a method for configuring the BWP described above, the initial BWP may be used for other system information (OSI), paging, and random access as well as the reception of the SIB.

SS/PBCH

The SS/PBCH block may refer to a physical layer channel block including a primary SS (PSS), a secondary SS (SSS), and a PBCH. More specifically, the SS/PBCH block may be defined as follows:

The PSS may serve as a reference for downlink time/frequency synchronization, and provide some information of a cell ID.

The SSS may serve as a reference for downlink time/frequency synchronization and providing the remaining cell ID information that is not provided by the PSS and may also serve as a reference signal for demodulation of the PBCH.

The PBCH may provide essential system information required for transmission or reception of a data channel and a control channel of a UE. The essential system information may include search space-related control information indicating radio resource mapping information of a control channel, scheduling control information for a separate data channel for transmission of system information, and the like.

The SS/PBCH block may include a combination of a PSS, an SSS, and a PBCH. One or multiple SS/PBCH blocks may be transmitted within 5 ms, and each of the transmitted SS/PBCH blocks may be distinguished by indices.

The UE may detect the PSS and the SSS in the initial access operation, and may decode the PBCH. The UE may obtain the MIB from the PBCH, and may be configured with CORESET#0. The UE may monitor the CORESET#0 under the assumption that a demodulation reference signal (DMRS) transmitted in the selected SS/PBCH block and the CORESET#0 is quasi-co-located (QCLed). The UE may receive system information through DCI transmitted from CORESET#0. The UE may obtain configuration information related to a RACH required for initial access from the received system information. The UE may transmit a physical RACH (PRACH) to the BS by considering the selected SS/PBCH index, and the BS having received the PRACH may obtain information about an SS/PBCH block index selected by the UE. The BS may know which block is selected among the SS/PBCH blocks by the UE, and may know that the CORESET#0 that corresponds to (or is associated with) an SS/PBCH block selected by the UE is monitored.

PDCCH: DCI

In the next generation mobile communication system (5G or NR system), scheduling information about a physical uplink shared channel (PUSCH) or a PDSCH transmission may be transmitted from a BS to a UE through DCI. The UE may monitor a fallback DCI format and a non-fallback DCI format with regard to the PUSCH or the PDSCH. The fallback DCI format may include a fixed field predefined between the BS and the UE, and the non-fallback DCI format may include a configurable field.

The DCI may be transmitted through a physical downlink control channel (PDCCH) after channel coding and modulation is performed thereon. A cyclic redundancy check (CRC) may be attached to a DCI message payload, and the CRC may be scrambled by a radio network temporary identifier (RNTI) corresponding to the identification information of the UE. Different RNTIs may be used to scramble CRC that is attached to the payload of the DCI message according to the purpose of the DCI message a UE-specific data transmission, a power control command, or a random access response. That is, the RNTI is not explicitly transmitted, but is included in a CRC calculation process and then transmitted. When receiving the DCI message transmitted through the PDCCH, the UE may identify a CRC by using an assigned RNTI. When a CRC check result is correct, the UE may know that the corresponding message has been transmitted to the UE.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling UE-specific PDSCH or PUSCH may be scrambled by a cell RNTI (C-RNTI).

DCI format 0_0 may be used as a fallback DCI for scheduling a PUSCH and a CRC may be scrambled by a C-RNTI. The DCI format 0_0 in which the CRC is scrambled by the C-RNTI may include pieces of information such as shown below in Table 3.

TABLE 3
Identifier for DCI formats-[1] bit
Frequency domain resource assignment-[┌log₂(N_{RB}^{UL,BWP} (N_{RB}^{UL,BWP} + 1)/2┐] bits
Time domain resource assignment-X bits
Frequency hopping flag-1 bit.
Modulation and coding scheme-5 bits
New data indicator-1 bit
Redundancy version-2 bits
HARQ process number-4 bits
Transmit power control (TPC) command for scheduled PUSCH-[2] bits
Uplink (UL)/Supplementary UL (SUL) indicator-0 or 1 bit

DCI format 0_1 may be used as a non-fallback DCI for scheduling a PUSCH and a CRC may be scrambled by a C-RNTI. The DCI format 0_1 in which the CRC is scrambled by the C-RNTI may include pieces of information as shown below in Table 4.

```
TABLE 4
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    For resource allocation type 0, ┌N_{RB}^{UL,BWP}/P┐ bits
    For resource allocation type 1, ┌log₂(N_{RB}^{UL,BWP}(N_{RB}^{UL,BWP} + 1)/2)┐
  bits
  Time domain resource assignment - 1, 2, 3, or 4 bits
  Virtual resource block (VRB)-to- physical resource block (PRB)
mapping) - 0 or 1 bit, only for resource allocation type 1.
    0 bit if only resource allocation type 0 is configured;
    1 bit otherwise.
  Frequency hopping flag - 0 or 1 bit, only for resource allocation
  type 1.
    0 bit if only resource allocation type 0 is configured;
    1 bit otherwise.
  Modulation and coding scheme - 5 bits
  New data indicator - 1 bit
  Redundancy version - 2 bits
  HARQ process number - 4 bits
  1st downlink assignment index - 1 or 2 bits
    1 bit for semi-static HARQ-ACK codebook;
    2 bits for dynamic HARQ-ACK codebook with single
    HARQ-ACK codebook.
  2nd downlink assignment index - 0 or 2 bits
    2 bits for dynamic HARQ-ACK codebook with two HARQ-ACK
    sub-codebooks;
    0 bit otherwise.
  TPC command for scheduled PUSCH - 2 bits
  $SRS resource indicator - ⌈ {log}_{2} ( {\sum }_{k = 1}^{{L}_{max}} ( \begin{matrix}{N}_{S R S} \\ k\end{matrix} ) ) ⌉ or ⌈ {log}_{2} ( {N}_{SRS} ) ⌉ bits$
    $⌈ {log}_{2} ( {\sum }_{k = 1}^{{L}_{max}} ( \begin{matrix}{N}_{S R S} \\ k\end{matrix} ) ) ⌉ bits for non - codebook based PUSCH$
    transmission;
    ┌log₂(N_{SRS})┐ bits for codebook based PUSCH transmission.
  Precoding information and number of layers -up to 6 bits
  Antenna ports - up to 5 bits
  SRS request - 2 bits
  Channel state information (CSI) request - 0, 1, 2, 3, 4, 5, or 6 bits
  Code block group (CBG) transmission information - 0, 2, 4, 6, or
  8 bits
  Phase tracking reference signal (PTRS)-Demodulation reference
signal (DMRS) association - 0 or 2 bits.
  beta_offset indicator - 0 or 2 bits
  Demodulation reference signal (DMRS) sequence initialization -
  0 or 1 bit
```

DCI format 1_0 may be used as a fallback DCI for scheduling a PDSCH and a CRC may be scrambled by a C-RNTI. In an embodiment, DCI format 1_0 in which the CRC is scrambled by the C-RNTI may include the following pieces of information as shown below in Table 5.

TABLE 5
Identifier for DCI formats-[1] bit
Frequency domain resource assignment[┌log₂(N_{RB}^{DL,BWP} (N_{RB}^{DL,BWP} + 1)/2┐] bits
Time domain resource assignment-X bits
VRB-to-PRB mapping-1 bit.
Modulation and coding scheme-5 bits
New data indicator-1 bit
Redundancy version-2 bits
HARQ process number-4 bits
Downlink assignment index-2 bits
TPC command for scheduled PUCCH-[2] bits
Physical uplink control channel (PUCCH) resource indicator-3 bits
PDSCH-to-HARQ feedback timing indicator-[3] bits

Alternatively, DCI format 1_0 may be used as DCI for scheduling a PDSCH for the RAR message and a CRC may be scrambled by an RA-RNTI. The DCI format 1_0 in which the CRC is scrambled by the C-RNTI may include pieces of information as shown below in Table 6.

TABLE 6
Frequency domain resource assignment-┌log₂(N_{RB}^{DL,BWP} (N_{RB}^{DL,BWP} + 1)/2┐ bits
N_{RB}^{DL,BWP} is the size of CORESET 0 if CORESET 0 is configured for the cell and
N_{RB}^{DL,BWP} is the size of initial DL bandwidth part if CORESET 0 is not configured for the cell
Time domain resource assignment-4 bits as defined in Subclause 5.1.2.1 of [6,
TS38.214]
VRB-to-PRB mapping-1 bit according to Table 7.3.1.2.2-5
Modulation and coding scheme-5 bits as defined in Subclause 5.1.3 of [6, TS38.214],
using Table 5.1.3.1-1
TB scaling-2 bits as defined in Subclause 5.1.3.2 of [6, TS38.214]

DCI format 1_1 may be used as a non-fallback DCI for scheduling a PDSCH and a CRC may be scrambled by a C-RNTI. In an embodiment, DCI format 1_1 in which the CRC is scrambled by the C-RNTI may include the following pieces of information as shown below in Table 7.

TABLE 7
Carrier indicator-0 or 3 bits
Identifier for DCI formats-[1] bits
Bandwidth part indicator-0, 1 or 2 bits
Frequency domain resource assignment
For resource allocation type 0, ┌N_{RB}^{DL,BWP}/P┐
For resource allocation type 1, ┌log₂(N_{RB}^{DL,BWP} (N_{RB}^{DL,BWP} + 1)/2┐
Time domain resource assignment-1, 2, 3, or 4 bits
VRB-to-PRB mapping-0 or 1 bit, only for resource allocation type 1.
0 bit if only resource allocation type 0 is configured;
1 bit otherwise.
Physical resource block (PRB) bundling size indicator-0 or 1 bit
Rate matching indicator-0, 1, or 2 bits
Zero power channel state information reference signal (ZP CSI-RS) trigger-0,
1, or 2 bits
For transport block 1:
Modulation and coding scheme-5 bits
New data indicator-1 bit
Redundancy version-2 bits
For transport block 2:
Modulation and coding scheme-5 bits
New data indicator-1 bit
Redundancy version-2 bits
HARQ process number-4 bits
Downlink assignment index-0 or 2 or 4 bits
TPC command for scheduled PUCCH-2 bits
PUCCH resource indicator-3 bits
PDSCH-to-HARQ_feedback timing indicator-3 bits
Antenna ports-4, 5 or 6 bits
Transmission configuration indication-0 or 3 bits
SRS request-2 bits
CBG transmission information-0, 2, 4, 6, or 8 bits
Code block group (CBG) flushing out information-0 or 1 bit
DMRS sequence initialization-1 bit

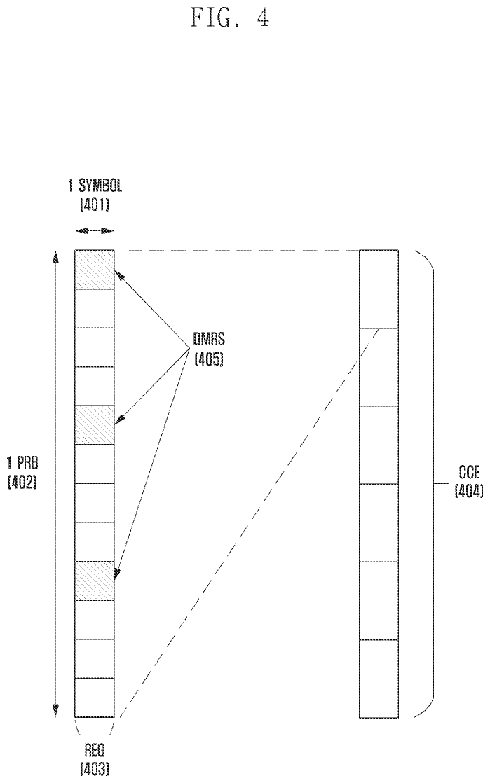

FIG. 4 illustrates the structure of a downlink control channel in a wireless communication system according to an embodiment. That is, FIG. 4 illustrates an example of a basic unit of time and frequency resources configuring a downlink control channel that can be used in 5G.

Referring to FIG. 4, the basic unit of time and frequency resources configuring a control channel may be referred to as an RE group (REG) 403 defined by one OFDM symbol 401 in a time axis and one physical resource block (PRB) 402, that is, 12 subcarriers, in a frequency domain. The BS may concatenate the REG 403 to configure a downlink control channel allocation unit.

As shown in FIG. 4, when a basic unit to which a downlink control channel is allocated in 5G is referred to as a control channel element (CCE) 404, one CCE 404 may include multiple REGs 403. The REG 403 may include 12 REs, and when one CCE 404 includes six REGs 403, one CCE 404 may include 72 REs. When the downlink control resource set is configured, the corresponding region may include multiple CCEs 404. A specific downlink control channel may be transmitted after being mapped to one or more CCEs 404 according to an aggregation level (AL) in the control resource set. The CCEs 404 in the control resource set are distinguished by numbers that may be assigned according to a logical mapping scheme.

The basic unit of the downlink control channel shown in FIG. 4, that is, the REG 403 may include both REs to which DCI is mapped and a region to which a DMRS 405 which is a reference signal for decoding the DCI is mapped. Three DMRSs 405 may be transmitted in one REG 403. The number of CCEs required for transmission of the PDCCH may be 1, 2, 4, 8, or 16 according to the aggregation level (AL). Different numbers of CCEs may be used to implement link adaptation of the downlink control channel. For example, when AL=L, one downlink control channel may be transmitted through L CCEs.

The UE needs to detect a signal when the UE does not know information about the downlink control channel, and a search space representing a set of CCEs has been defined for blind decoding. The search space is a set of downlink control channel candidates including CCEs that the UE has to attempt to decode at a given AL. Since there are various ALs that compose one bundle of 1, 2, 4, 8, or 16 CCEs, the UE may have multiple search spaces. A search space set may be defined as a set of search spaces at all configured ALs.

The search space may be classified into a common search space and a UE-specific search space. A predetermined group of UEs or all the UEs may examine the common search space of the PDCCH so as to receive cell common control information such as dynamic scheduling of system information or a paging message.

For example, the UE may examine the common search space of the PDCCH so as to receive PDSCH scheduling allocation information for transmission of the SIB including cell operator information and the like. In a case of the common search space, since a predetermined group of UEs or all the UEs should receive the PDCCH, the common search space may be defined as a set of previously promised CCEs. However, the UE may examine the UE-specific search space of the PDCCH so as to receive scheduling allocation information about the UE-specific PDSCH or PUSCH. The UE-specific search space may be UE-specifically defined as a function of the UE identity and various system parameters.

In 5G, the parameter for the search space of the PDCCH may be configured for the UE by the BS via higher layer signaling (e.g., SIB, MIB, RRC signaling, etc.). For example, the BS may configure, in the UE, the number of PDCCH candidates at each aggregation level L, the monitoring periodicity for the search space, the monitoring occasion of symbol units in the slots for the search space, the search space type (common search space or UE-specific search space), a combination of RNTI and DCI format to be monitored in the search space, and the control resource set index to monitor the search space. The configuration described above may include the following pieces of information as shown below in Table 8.

TABLE 8

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| | |
|---|---|
| searchSpaceId | SearchSpaceId, |

(Search space identity)

| | |
|---|---|
| controlResourceSetId | ControlResourceSetId, |

(Control resource set identity)

| | |
|---|---|
| monitoringSlotPeriodicityAndOffset | CHOICE { |

(Monitoring slot level period)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

```
    }
      OPTIONAL,
```

| | |
|---|---|
| duration(Monitoring length) | INTEGER |

(2..2559)

| | |
|---|---|
| monitoringSymbolWithinSlot | BIT SRING (SIZE (14)) |
| | OPTIONAL, |

(Monitoring symbol in slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, |

n4, n5, n6, n8},

| | |
|---|---|
| aggregationLevel2 | ENUMERATED {n0, n1, n2, n3, |

n4, n5, n6, n8},

| | |
|---|---|
| aggregationLevel4 | ENUMERATED {n0, n1, n2, n3, |

n4, n5, n6, n8},

| | |
|---|---|
| aggregationLevel8 | ENUMERATED {n0, n1, n2, n3, |

n4, n5, n6, n8},

| | |
|---|---|
| aggregationLevel16 | ENUMERATED {n0, n1, n2, n3, |

n4, n5, n6, n8}
},

| | |
|---|---|
| searchSpaceType | CHOICE { |

```
    (Search space type)
      -- Configures this search space as common search space (CSS) and DCI
formats to monitor.
      common
    SEQUENCE {
    (Common search space)
      }
```

| | |
|---|---|
| ue-Specific | SEQUENCE { |

```
    (UE-specific search space)
        -- Indicates whether the UE monitors in this USS for DCI formats
0-0 and 1-0 or for formats 0-1 and 1-1.
```

| | |
|---|---|
| formats | ENUMERATED {formats0-0-And-1-0, |
| formats0-1-And-1-1}, | |

```
        ...
      }
```

The BS may configure one or more search space sets for the UE according to configuration information. The BS may configure search space set 1 and search space set 2 in the UE. The BS may be configured to the allow the search space set 1 to monitor DCI format A scrambled by an X-RNTI in the common search space, and to allow the search space set 2 to monitor DCI format B scrambled by a Y-RNTI in the UE-specific search space.

According to the configuration information, one or multiple search space sets may exist in the common search space or the UE-specific search space. For example, search space set #1 and search space set #2 may be configured as the common search space, and search space set #3 and search space set #4 may be configured as the UE-specific search space.

The common search space may be categorized into specific types of search space sets based on its purpose. RNTIs to be monitored may be different for each determined type of search space set. For example, the type of common search space, purpose, and the RNTIs to be monitored may be categorized as shown below in Table 9.

TABLE 9

| Search space type | Purpose | RNTI |
|---|---|---|
| Type0 CSS | PDSCH transmission for SIB | SI-RNTI |
| | scheduling | |
| Type0A CSS | PDCCH transmission for SI | SI-RNTI |
| | scheduling other than SIB1 | |
| | (SIB2, etc.) | |
| Type1 CSS | PDCCH transmission for | RA-RNTI, TC-RNTI |
| | random access response (RAR) | |
| | scheduling, Msg3 | |
| | retransmission scheduling, and | |
| | Msg4 scheduling | |
| Type2 CSS | Paging | P-RNTI |
| Type3 CSS | Transmission of group control | INT-RNTI, SFI-RNTI, |
| | information | TPC-PUSCH-RNTI, |
| | | TPC-PUCCH RNTI, |
| | | TPC-SRS-RNTI |
| | For PCell, PDCCH | C-RNTI, MCS-C-RNTI, |
| | transmission for data scheduling | CS-RNTI |

However, in the common search space, the following combinations of the DCI format and the RNTI may be monitored but are not limited thereto.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of the DCI format and the RNTI may be monitored. However, the combinations of the DCI format and the RNTI are not limited thereto.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the definitions and usages described below.
C-RNTI (Cell RNTI): For UE-specific PDSCH scheduling
Temporary cell RNTI (TC-RNTI): For UE-specific PDSCH scheduling
Configured scheduling RNTI (CS-RNTI): For semi-statically configured UE-specific PDSCH scheduling
Random access RNTI (RA-RNTI): For PDSCH scheduling in random access operation
Paging RNTI (P-RNTI): For scheduling of PDSCH through which paging is transmitted
System information RNTI (SI-RNTI): For PDSCH scheduling in which system information is transmitted
Interruption RNTI (INT-RNTI): For notifying of whether to puncture the PDSCH
Transmit power control for PUSCH RNTI (TPC-PUSCH-RNTI): For indication of power control command for the PUSCH
Transmit power control for PUCCH RNTI (TPC-PUCCH-RNTI): For indication of power control command for the PUCCH
Transmit power control for SRS RNTI (TPC-SRS-RNTI): For indication of power control command for the SRS

The above-described DCI formats may be defined as shown below in Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

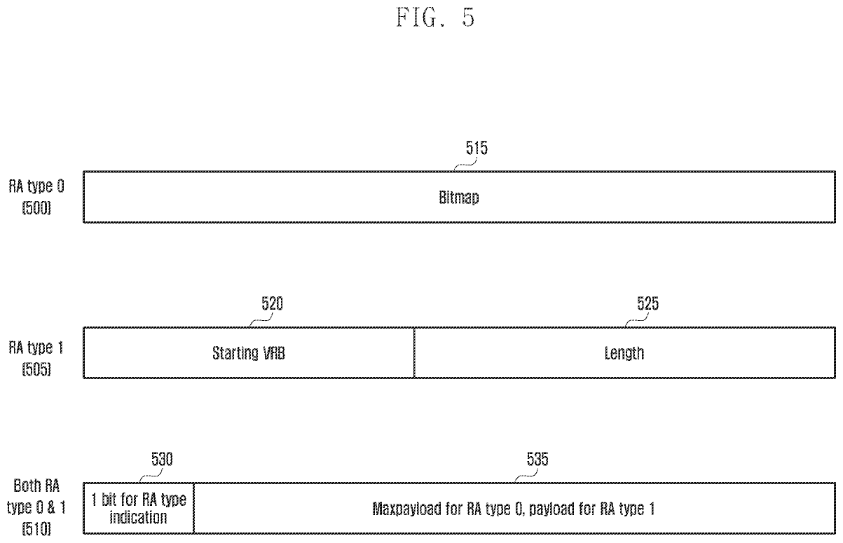

FIG. 5 illustrates an example of frequency-domain resource allocation of a PDSCH in a wireless communication system according to an embodiment.

FIG. 5 shows three frequency-domain resource allocation methods of type 0 500, type 1 505, and dynamic switch 510 configurable through a higher layer in NR.

Referring to FIG. 5, in case that a UE is configured to use only resource type 0 via higher layer signaling (indicated by reference numeral 500), some DCI for allocation of PDSCH to the corresponding UE includes a bitmap formed of a the number of resource block group (NRBG) bits, which are determined as shown below in Table 11 according to a BWP size allocated by a BWP indicator and a higher layer parameter rbg-Size. Data is transmitted on an RBG indicated by “1” according to the bitmap.

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

When the UE is configured to use only resource type 1 via higher layer signaling (indicated by reference numeral 505), some DCI for allocation of the PDSCH to the UE includes frequency-domain resource allocation information configured by ┌log₂(N_{RB}^{DL,BWP}(N_{RB}^{DL,BWP}+1)/2┐ bits. Through this information, the BS may configure a starting VRB 520 and the length of frequency-domain resources 525 continuously allocated therefrom.

When the UE is configured to use both resource type 0 and resource type 1 via higher layer signaling (indicated by reference numeral 510), some DCI for allocation of PDSCH to the UE includes frequency-domain resource allocation information configured by bits of a greater value 535 among a payload 515 for configuration of resource type 0 and payloads 520 and 525 for configuration of resource type 1. One bit is added to the most significant bit (MSB) of the frequency-domain resource allocation information in the DCI, in case that the corresponding bit has a value of “0”, 0 indicates that resource type 0 is used, and in case that the corresponding bit has a value of “1”, 1 indicates that resource type 1 is used.

A BS may configure, for a UE, a table for time-domain resource allocation information for a PDSCH and a PUSCH transmission via higher layer signaling (e.g., RRC signaling). With regard to the PDSCH, the BS may configure a table including up to 16 (maxNrofDL-Allocations=16) entries, and with regard to the PUSCH, a table including up to 16 (maxNrofUL-Allocations=16) entries. The time-domain resource allocation information may include PDCCH-to-PDSCH slot timing (corresponding to a time interval in slot units between a time point at which a PDCCH is received and a time point at which a PDSCH scheduled by the received PDCCH is transmitted, and denoted as K0), PDCCH-to-PUSCH slot timing (corresponding to a time interval in slot units between a time point at which a PDCCH is received and a time point at which a PUSCH scheduled by the received PDCCH is transmitted, and denoted as K2), information on the location and length of a start symbol in which the PDSCH or PUSCH is scheduled in the slot, and a mapping type of PDSCH or PUSCH. For example, information such as shown below in Table 12 or Table 13 may be transmitted from the BS to the UE.

TABLE 12
PDSCH-TimeDomainResourceAllocationList information element

| | |
|---|---|
| PDSCH-TimeDomainResourceAllocationList ::= | SEQUENCE (SIZE(1..maxNrofDL-Allocations)) OF |

PDSCH-TimeDomainResourceAllocation

| | |
|---|---|
| PDSCH-TimeDomainResourceAllocation ::= | SEQUENCE { |

| | |
|---|---|
| k0 | INTEGER(0..32) |

OPTIONAL, -- Need S
(PDCCH-to-PDSCH timing, slot untis)

| | |
|---|---|
| mappingType | ENUMERATED {typeA, typeB}, |

(PDSCH mapping type)

| | |
|---|---|
| startSymbolAndLength | INTEGER (0..127) |

```
  (start symbol and length of PDSCH)
  }
```

TABLE 13
PUSCH-TimeDomainResourceAllocation information element

| | | |
|---|---|---|
| PUSCH-TimeDomainResourceAllocationList ::= | SEQUENCE | (SIZE(1..maxNrofUL- |

Allocations)) OF PUSCH-TimeDomainResourceAllocation

| PUSCH-TimeDomainResourceAllocation ::= | SEQUENCE { | |
|---|---|---|
| k2 | INTEGER(0..32) | OPTIONAL, |

-- Need S
(PDCCH-to-PUSCH timing, slot units)

| | |
|---|---|
| mappingType | ENUMERATED {typeA, typeB}, |

(PUSCH mapping type)

| | |
|---|---|
| startSymbolAndLength | INTEGER (0..127) |

```
    (Start symbol and length of PUSCH)
  }
```

The BS may notify the UE of one of the entries in the table representing the time-domain resource allocation information via L1 signaling (e.g., DCI) (e.g., may be indicated by a “time-domain resource allocation” field in DCI). The UE may acquire time-domain resource allocation information for the PDSCH or PUSCH based on the DCI received from the BS.

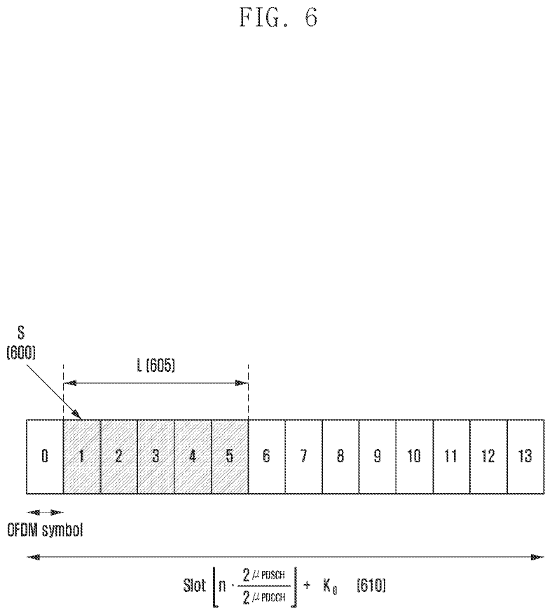

FIG. 6 illustrates an example of time-domain resource allocation of a PDSCH in a wireless communication system according to an embodiment.

Referring to FIG. 6, a BS may indicate a time-domain position of a PDSCH resource according to a start (S) position 600 and a length (L) 605 of an OFDM symbol in a slot 610 dynamically indicated via the subcarrier spacing (SCS) (μ_{PDSCH}, μ_{PDCCH}) of a data channel and a control channel configured via a higher layer, a scheduling offset (K₀) value, and DCI.

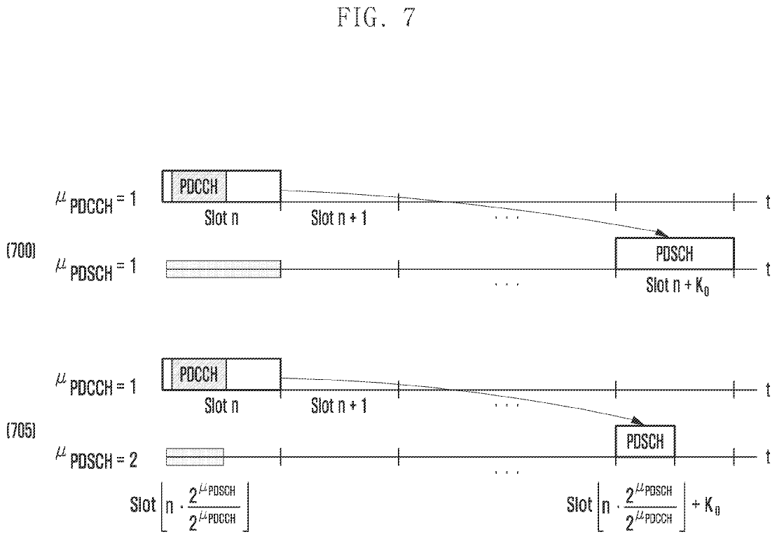

FIG. 7 illustrates an example of time-domain resource allocation according to the subcarrier spacing of a data channel and a control channel in a wireless communication system according to an embodiment.

Referring to FIG. 7, in case that a data channel and a control channel have the same subcarrier spacing (indicated by reference numeral 700, μ _{PDSCH}=μ_{PDCCH}), since a data slot number and a control slot number are the same, a BS and a UE may recognize that a scheduling offset occurs according to predetermined slot offset K0. However, when the subcarrier spacing of the data channel and the subcarrier spacing of the control channel are different (indicated by reference numeral 705, μ_{PDSCH}≠μ_{PDCCH}), since a data slot number and a control slot number are different, the BS and the UE may recognize that a scheduling offset occurs according to the predetermined slot offset K0 based on the subcarrier spacing of the PDCCH.

QCL, TCI state

In a wireless communication system, one or more different antenna ports (or, which may be replaced by one or more channels, signals, and combinations thereof, but will be referred to collectively as different antenna ports for convenience) may be associated with each other in a quasi-co-location (QCL) configuration as shown in Table 16 below. The TCI state is for notifying of a QCL relationship between a PDCCH (or PDCCH DMRS) and another RS or channel When a reference antenna port A (reference RS #A) is QCLed with another target antenna port B (target RS #B), it may be understood that the UE is allowed to apply all or some of large-scale channel parameters estimated from the antenna port A to channel measurement from the antenna port B. QCL may be required to associate different parameters according to situations such as 1) time tracking affected by average delay and delay spread, 2) frequency tracking affected by Doppler shift and Doppler spread, 3) radio resource management (RRM) affected by average gain, and 4) beam management (BM) affected by a spatial parameter. Accordingly, 5G may support four types of QCL relationships as shown below in Table 14.

TABLE 14

| QCL type | Large-scale characteristics |
|---|---|
| A | Doppler shift, Doppler spread, average delay, delay |
| | spread |
| B | Doppler shift, Doppler spread |
| C | Doppler shift, average delay |
| D | Spatial Rx parameter |

The spatial RX parameter may collectively refer to some or all of various parameters such as angle of arrival (AoA), power angular spectrum (PAS) of AoA, angle of departure (AoD), PAS of AoD, transmit/receive channel correlation, transmit/receive beamforming, and spatial channel correlation.

The QCL relationship may be configured for the UE via TCI-State and QCL-Info, which are RRC parameters, as shown below in Table 15. Referring to Table 15, the BS may configure the UE with one or more TCI states to inform the UE of a maximum of two QCL relationships (qcl-Type1 and qcl-Type2) for a RS referencing an ID of the TCI state, i.e., a target RS. In this case, each piece of QCL information (QCL-info) included in the TCL state may include a serving cell index and a BWP index of a reference RS indicated by the corresponding QCL information, a type and an ID of the reference RS, and a QCL type as shown above in Table 14.

TABLE 15

| TCI-State ::= | SEQUENCE { |
|---|---|
| tci-StateId | TCI-StateId, |
| (ID of TCI state) | |
| qcl-Type 1 | QCL-Info, |
| (QCL information of first reference RS of RS (target RS) | |
| referencing the TCI | |
| state ID) | |
| qcl-Type2 | QCL-Info |
| OPTIONAL, -- Need R | |
| (QCL information of second reference RS of RS (target RS) | |
| referencing the | |
| TCI state ID) | |
| ... | |
| } | |
| QCL-Info ::= | SEQUENCE { |
| cell | ServCellIndex |
| OPTIONAL, -- Need R | |
| (serving cell index of reference RS indicated by QCL | |
| information) | |
| bwp-Id | BWP-Id |
| OPTIONAL, -- Cond CSI-RS-Indicated | |
| (BWP index of reference RS indicated by QCL information) | |
| referenceSignal | CHOICE { |
| csi-rs | NZP-CSI-RS- |
| ResourceId, | |
| ssb | SSB- |
| Index | |
| (one of CSI-RS ID or SSB ID indicated by QCL | |
| information) | |
| }, | |
| qcl-Type | ENUMERATED |

{typeA, typeB, typeC, typeD},
...
}

HARQ-ACK Feedback Transmission Method and Apparatus

The NR system employs a HARQ scheme for retransmitting corresponding data in a physical layer when a decoding failure occurs in the initial transmission. In the HARQ scheme, when failing to correctly decode data, a receiver transmits a negative ACK (NACK) indicating a decoding failure to a transmitter so that the transmitter is enabled to retransmit the data in the physical layer. The receiver may improve data reception performance by combining data retransmitted by the transmitter with data that has previously failed to be decoded. In addition, when correctly decoding data, the receiver transmits an ACK indicating a decoding success to the transmitter so that the transmitter is enabled to transmit new data.

Hereinafter, the disclosure describes a method and apparatus for transmitting HARQ-ACK feedback in response to downlink data transmission. Specifically, a method for constructing HARQ-ACK feedback bits when the UE intends to transmit multiple HARQ-ACKs in one slot through uplink will be described.

In the NR system, a BS may configure one CC or a plurality of CCs for downlink transmission to the UE. In addition, a slot and a symbol for downlink transmission and uplink transmission may be configured for each CC. When a PDSCH is scheduled, at least one of slot timing information relating to a slot to which the PDSCH is mapped, and information relating to the position of a start symbol to which the PDSCH is mapped in the corresponding slot, and the number of symbols to which the PDSCH is mapped may be transmitted in a particular bit field of DCI. For example, when DCI is transmitted through slot n, and a PDSCH is scheduled, if slot timing information K0 relating to a slot through which the PDSCH is transmitted indicates 0, a start symbol position is 0, and a symbol length is 7, the corresponding PDSCH is transmitted after being mapped to seven symbols from a symbol number 0 of the slot n. However, after K1 slot from transmission of PDSCH, the HARQ-ACK feedback may be transmitted from the UE to the BS. K1 information, which is timing information relating to HARQ-ACK transmission, may be transmitted through the DCI. A candidate set of possible K1 values may be delivered via higher layer signaling, and one of these values may be determined through the DCI.

When the UE is configured with a semi-static HARQ-ACK codebook, the UE may determine the feedback bit (or HARQ-ACK codebook size) to be transmitted, based on a table including at least one of slot information K0 relating to a slot through which the PDSCH is mapped, start symbol information, the number of symbols, or length information, and based on K1 candidate values of HARQ-ACK feedback timing information for PDSCH. The table including at least one of slot information relating to a slot through which the PDSCH is mapped, start symbol information, the number of symbols, or length information may be based on a default value or may be configured in the UE by the BS.

When the UE is configured with a dynamic HARQ-ACK codebook, the UE may determine HARQ-ACK feedback bits (or HARQ-ACK codebook size) to be transmitted by the UE, based on downlink assignment indicator (DAI) information included in the DCI in a slot for transmission of HARQ-ACK information determined according to slot information K0 relating to a slot through which the PDSCH mapped and HARQ-ACK feedback timing information K1 value for the PDSCH.

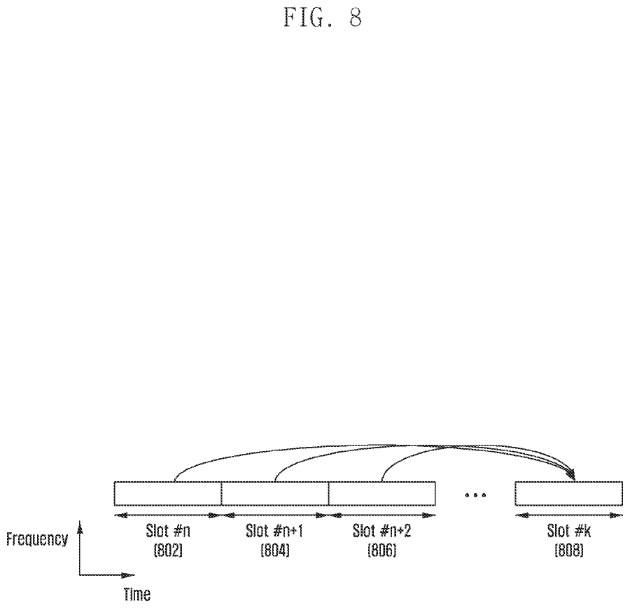

FIG. 8 illustrates a method for configuring a semi-static HARQ-ACK codebook in an NR system according to an embodiment.

When the number of HARQ-ACK PUCCHs that the UE can transmit in one slot is limited to one, and the UE receives a higher layer signal for configuring a semi-static HARQ-ACK codebook, the UE may report HARQ-ACK information for PDSCH reception or SPS PDSCH release in the HARQ-ACK codebook through a slot that is indicated by a value of a PDSCH-to-HARQ_feedback timing indicator field included in DCI format 1_0 or DCI format 1_1. The UE may report a HARQ-ACK information bit value in the HARQ-ACK codebook as a NACK through a slot that is not indicated by a value of a PDSCH-to-HARQ_feedback timing indicator field included in DCI format 1_0 or DCI format 1_1. When the UE reports only HARQ-ACK information for one SPS PDSCH release or one PDSCH reception in MA_{A,C} occasions for candidate PDSCH reception, and the report is scheduled by DCI format 1_0 including information indicating “1” in the counter DAI field in a Pcell, the UE determines one HARQ-ACK codebook for the corresponding SPS PDSCH release or the corresponding PDSCH reception.

The other cases follow a method of determining the HARQ-ACK codebook according to the method described below.

Assuming that a set of PDSCH reception candidate occasions in a serving cell c is M_{A,c}, the M_{A,c} may be obtained by the following pseudo-code 1 stages.
Start pseudo-code 1
Stage 1: initializing j to 0 and M_{A,c} to an empty set. Initialize k, which is HARQ-ACK transmission timing index, to 0.
Stage 2: configuring R as a set of rows in a table including slot information relating to a slot to which a PDSCH is mapped, starting symbol information, and information of the number or length of symbols. When a PDSCH-available mapping symbol indicated by each value of R is configured as a UL symbol according to DL and UL configurations configured via higher layer signaling, removing a corresponding row from R.
Stage 3-1: receiving, by a UE, one unicast PDSCH in one slot, and when R is not an empty set, adding one PDSCH to the set M_{A,c}.
Stage 3-2: when the UE is able to receive two or more PDSCHs for unicast in one slot, counting the number of PDSCHs allocatable in different symbols from the calculated R, and adding the counted number of PDSCHs to M_{A,c}.
Stage 4: increasing k by one and restarting from stage 2.
End pseudo-code 1

Referring to FIG. 8, the above pseudo-code 1 is described as follows. In order to perform HARQ-ACK PUCCH transmission in a slot #k 808, a UE may consider all slot candidates in which a PDSCH-to-HARQ-ACK timing that can indicate slot #k 808 is possible. In FIG. 8, it is assumed that HARQ-ACK transmission is possible in a slot #k 808 by a combination of PDSCH-to-HARQ-ACK timings that are possible by only PDSCHs scheduled in slot #n 802, slot #(n+1) 804, and a slot #(n+2) 806. In consideration of time-domain resource configuration information of a PDSCH which can be scheduled in each of the slots 802, 804, and 806, and information indicating whether a symbol in a slot corresponds to the downlink or the uplink, the number of PDSCHs which can be maximally scheduled for each slot may be derived. For example, assuming that two PDSCHs can be maximally scheduled in slot 802, three PDSCHs can be maximally scheduled in slot 804, and two PDSCHs can be maximally scheduled in slot 806, the maximum number of PDSCHs included in an HARQ-ACK codebook transmitted in slot 808 is 7 in total. This is referred to as the cardinality of the HARQ-ACK codebook.

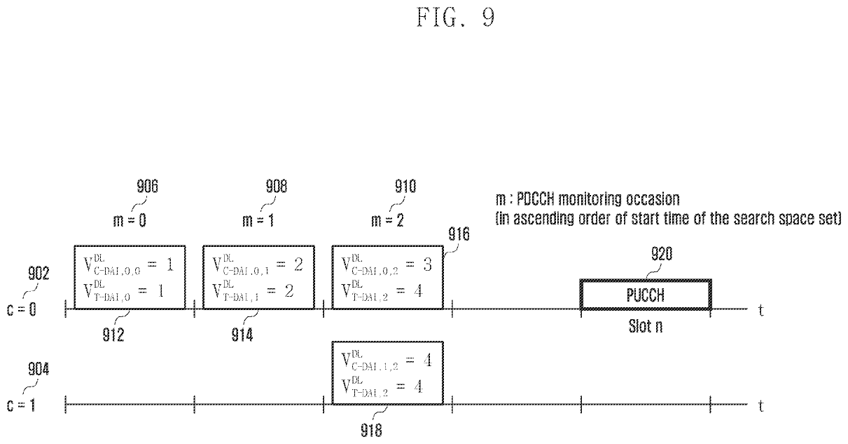

FIG. 9 illustrates a method for configuring a dynamic HARQ-ACK codebook in an NR system according to an embodiment.

Based on a PDSCH-to-HARQ_feedback timing value for PUCCH transmission of HARQ-ACK information for PDSCH reception or SPS PDSCH release, and K0, which is transmission slot location information of the PDSCH scheduled in DCI format 1_0 or 1_1, a UE may transmit HARQ-ACK information transmitted within one PUCCH in the corresponding slot n.

Specifically, for transmission of the above-described HARQ-ACK information, the UE may determine a HARQ-ACK codebook of the PUCCH transmitted in the slot determined by the PDSCH-to-HARQ_feedback timing and K0 based on DAI included in the DCI indicating PDSCH or SPS PDSCH release.

The DAI includes counter DAI and total DAI. The counter DAI indicates the position of HARQ-ACK information corresponding to the PDSCH scheduled in DCI format 1_0 or DCI format 1_1 in the HARQ-ACK codebook. Specifically, the value of counter DAI in DCI format 1_0 or 1_1 informs a cumulative value of PDSCH reception or SPS PDSCH release scheduled by DCI format 1_0 or DCI format 1_1 in a specific cell c. The above-described cumulative value is configured based on PDCCH monitoring occasion and a serving cell in which the scheduled DCI exists.

The total DAI is a value indicating the size of the HARQ-ACK codebook. Specifically, the value of total DAI implies the total number of previously scheduled PDSCH or SPS PDSCH releases including a time point at which DCI is scheduled (i.e., a PDCCH monitoring occasion). The total DAI is a parameter used when the HARQ-ACK information in the serving cell c also includes HARQ-ACK information for the PDSCH scheduled in another cell including the serving cell c in a carrier aggregation (CA) situation. In other words, there is no total DAI parameter in a system operating with one cell.

FIG. 9 illustrates an example of the operation of a UE associated in the DAI when a dynamic HARQ-ACK codebook is used. In FIG. 9, when the UE transmits a HARQ-ACK codebook selected based on the DAI to the PUCCH 920 in an nth slot of a carrier 0 (indicated by reference numeral 902) when two carriers (c) are configured for the UE, changes in the values of counter DAI (C-DAI) and total DAI (T-DAI) indicated by DCI retrieved for each PDCCH monitoring occasion configured for each carrier are shown. In the DCI retrieved at m=0 (indicated by reference numeral 906), C-DAI and T-DAI indicate a value of 1 (indicated by reference numeral 912), respectively. The DCI retrieved at m=1 (indicated by reference numeral 908) indicates a value in which C-DAI and T-DAI are 2 (indicated by reference numeral 914), respectively. In the DCI retrieved in carrier 0 (c=0, reference numeral 902) of m=2 (indicated by reference numeral 910), C-DAI indicates a value of 3 (indicated by reference numeral 916). In the DCI retrieved in carrier 1 (c=1, reference numeral 904) of m=2 (indicated by reference numeral 910), C-DAI indicates a value of 4 (indicated by reference numeral 918). At this time, when carriers 0 and 1 are scheduled on the same monitoring occasion, T-DAI is all indicated as 4.

In FIGS. 8 and 9, the HARQ-ACK codebook determination may be performed in a situation where only one PUCCH containing HARQ-ACK information is transmitted in one slot. As an example, when PDSCHs scheduled in different pieces of DCI are multiplexed into one HARQ-ACK codebook in the same slot, and the codebook is transmitted, the PUCCH resource selected for HARQ-ACK transmission is determined to be a PUCCH resource indicated by the PUCCH resource field indicated in DCI that lastly scheduling a PDSCH. That is, a PUCCH resource indicated by a PUCCH resource field indicated in DCI scheduled before the DCI is disregarded.

Network-Controlled Repeater (NCR)

Coverage is an important factor in a wireless communication system, and 5G is currently being commercialized and mmWave is also included in the commercialization. However, due to the limited coverage, there is not much actual use. Many service providers are looking for a method of economically operating communication systems while providing stable coverage at the same time. Service providers may consider installing multiple base stations, but the high cost has led them to look for a more cost-effective method.

For this reason, the first technology considered is an integrated access and backhaul (IAB), which has been studied over Rel-16 and Rel-17. The IAB is a kind of relay that does not require a wired backhaul network, and performs relaying of signals between a base station and a UE. The IAB has a similar performance to that of a base station, to thereby having the disadvantage of increasing costs. Second, conventional RF repeaters may be considered. The conventional RF repeaters are the most basic unit of repeater, which amplify a received signal and transmit the amplified signal. The conventional RF repeaters have the advantage of being inexpensive because they perform amplification and transmission simply, but they cannot actively respond to various situations. As an example, conventional RF repeaters typically use omni antennas rather than directional antennas, and thus beamforming gain cannot be obtained using conventional RF repeaters. In addition, conventional RF repeaters may be a source of interference because they amplify and transmit noise even when there are no terminals connected to the conventional RF repeater. The IABs and conventional RF repeaters show that their advantages and disadvantages are biased in terms of performance and cost. In order to realistically increase coverage, not only performance but also cost should be considered, and thus the need for a new terminal or amplifier is emerging.

In 3GPP Rel-18, research on an NCR, which maximizes coverage by enabling the implementation of beamforming technology with an adaptive antenna while maintaining the simple signal amplification and transmission operation of the RF repeater, is in progress. In order for the NCR to transmit a signal to a terminal by using an adaptive antenna within a cell, the NCR should be able to receive a control signal from a base station. Therefore, the NCR should be able to detect and decode the control signal of the base station, and have a function of transmitting and receiving a control signal similar to that of the terminal.

The NCR may basically perform an operation of receiving a signal transmitted from a base station and then amplifying the received signal so as to transmit the amplified signal to a UE, and receiving a signal transmitted from a UE and then amplifying the received signal to transmit the amplified signal to a base station. That is, the NCR may only amplify and transmit a signal or channel transmitted and received between the base station and the UE without detecting or decoding the signal or channel Therefore, a UE may not recognize whether the NCR is involved in communication between the base station and the UE. In other words, a UE is unable to distinguish between a base station and an NCR, and the NCR may appear to be a base station. Since a UE does not need any additional information or operation for the NCR, a UE supporting any release can be supported by the NCR.

As described above, from the point of view of a base station, the NCR may be seen as a general type of UE. When the NCR is first installed, the NCR may perform an initial access to the base station like a general terminal, and after a higher layer connection (e.g., RRC connection) is established, may receive a configuration that a UE would normally receive from the base station. The NCR may perform an operation of amplifying a signal and transmitting the amplified signal after being connected to the base station. From the point of view of the base station, it is necessary to know whether the UE is directly connected to the base station or connected through the NCR. In case that a UE is within the coverage of the NCR, the UE may communicate with the base station through the NCR, and the base station may recognize this through its implementation.

The base station may know which UE performs communication through which NCR, but the NCR is unable to know this fact. Regardless of whether a UE is located within its coverage or not, the NCR may perform an operation of amplifying a signal and transmitting the amplified signal to the UE under the control of the base station. In order for the base station to control the NCR, a control signal that plays a similar role to that of the DCI may be required. In the disclosure, this control signal is defined as side control information (SCI) for convenience. The SCI is not limited to the terms described in this disclosure, and other terms having equivalent technical meanings, such as repeater-DCI (R-DCI), repeater control information (RCI), and network-controlled repeater control information (NCI) may be used. The SCI refers to control information transmitted by the base station to control the NCR, and may be information (or signal) which is unknown to the terminal and perceived only by the base station and the NCR.

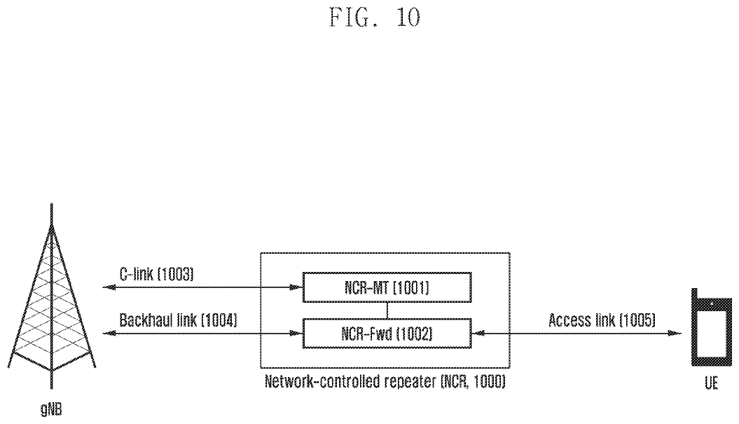

FIG. 10 illustrates an example of transmission and reception related to an NCR when the NCR performs relaying between a BS and a UE according to an embodiment.

Referring to FIG. 10, disclosed is an operation in which an NCR 1000 relays communication (e.g., downlink, uplink) between a BS and a UE. The NCR should include a structure capable of transmitting and receiving control signaling of the BS, the transmission and reception are possible in a network-controlled repeater-mobile termination (NCR-MT) 1001. The NCR-MT 1001 may receive control signaling through a control link (C-link) 1003, and may transmit feedback. That is, from the point of view of the BS, the NCR-MT 1001 appears to be a general UE, and thus the BS may perform communication.

The BS may control a network-controlled repeater-forwarding (NCR-Fwd) 1002 by transmitting control signaling to the NCR-MT 1001. The NCR-Fwd 1002 may include only a basic RF or physical layer, and may perform an operation of amplifying a signal and forwarding the amplified signal to a UE. The NCR-Fwd 1002 may receive a signal transmitted from the BS through a backhaul link 1004 in downlink and forward the signal to the UE through an access link 1005. Since the backhaul link 1004 and the C-link 1003 are not necessarily physically separated links, the NCR may perform amplification and forwarding of the signal, and at the same time, may detect SCI, which is configured by the BS to indicate the operation of the NCR, through the C-link 1003. In a case of uplink, the NCR may perform an operation of receiving an uplink signal transmitted by the UE through an access link 1005, and amplifying and forwarding the uplink signal to the BS through the backhaul link 1004. The NCR may transmit uplink feedback or SRS for control through the SCI or higher layer signaling to the BS. Assuming that the NCR-MT 1001 part of the NCR is the same as that of a general UE, it would be reasonable for the NCR to transmit uplink feedback.

As described above, in the downlink, the NCR may amplify and forward a downlink signal to the UE while detecting the SCI at the same time. The above operation may be possible when the NCR may simultaneously search for SCI while performing an operation of amplification and forwarding of the signal. Since SCI search requires low complexity, the NCR will be able to perform the above operation without additional cost. However, in the uplink, an operation in which the NCR itself transmits uplink feedback, and at the same time, amplifies and forwards the uplink signal of the UE, may be performed irrespective of the NCR implementation.

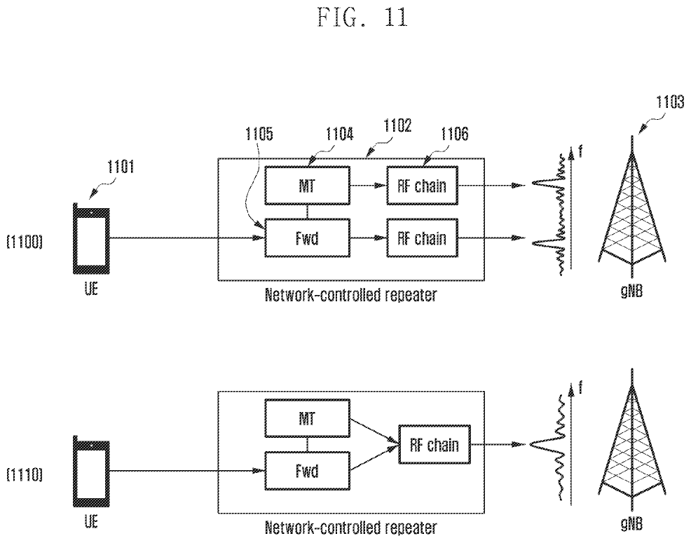

FIG. 11 illustrates an example of uplink transmission according to an RF chain when an NCR performs relaying between a BS and a UE according to an embodiment.

Referring to FIG. 11, a UE 1101 may transmit an uplink signal to a BS 1103 after being relayed by an NCR 1102. Reference numeral 1100 in FIG. 11 shows an example in which an NCR-MT 1104 and an NCR-Fwd 1105 are connected to different RF chains 1106, respectively, and reference numeral 1110 shows an example in which the NCR-MT and the NCR-Fwd are connected to the same RF chain. The RF chain is configured by a single radio link and a series of RF processing elements (e.g., antennas, power amplifiers, mixers) connected in the manner of a chain, and may usually perform a role of converting a digital signal to an analog signal, and then converting a baseband signal to a carrier frequency signal and transmitting the signal through multiple filters. In general, one RF chain is used for one stream. Therefore, in reference numeral 1100, since a signal transmitted by the UE and a signal transmitted by the NCR-MT in the uplink are transmitted to the BS through different RF chains, the signals may be transmitted respectively on different frequency domains within the same period of time. However, in reference numeral 1110, when the signal transmitted by the UE and the signal transmitted by the NCR-MT correspond to different streams, the signals are unable to be simultaneously transmitted through the same RF chain. When the signal transmitted by the UE and the signal to be transmitted by the NCR-MT are multiplexed, the signals can be transmitted through one RF chain.

The NCR performs an operation of amplifying and forwarding signals under the control of the BS, by using the above-described NCR-MT and NCR-Fwd structures. Since signal amplification and forwarding are to amplify the configured bandwidth as it is, noise and neighbor cell interference may also be amplified and forwarded. For example, when multiple NCRs transmit signals to a BS in the uplink, the signal-to-noise ratio (SNR) of the BS will deteriorate due to an increase in the noise floor of the BS. In addition, there is a possibility that the adjacent channel leakage ratio (ACLR) will increase due to poor filter performance and the low-cost nature of the NCR. When the amplifying gain for the NCR is too large, the performance of the entire system will decrease due to the interference. However, the coverage of the NCR will decrease when the amplifying gain is excessively reduced due to the disadvantage of the NCR that amplifies noise, and thus it will be difficult to support a cell-edge UE. Therefore, the BS needs to configure an appropriate amplifying gain for the NCR depending on the occasion to maximize the performance of the entire system.

### FIRST EXAMPLE

### Semi-Static Amplifying Gain Control for Network-Controlled Repeater

In the first example, a method in which an NCR receives semi-static signaling from a BS and controls an amplifying gain operation of an NCR-Fwd is described. The amplifying gain operation of the NCR-Fwd may correspond to an operation of amplifying the strength of a received signal by a predetermined multiple of the strength in case that the NCR performs an operation of amplifying and forwarding of the signal. In this operation, configuring and instructing the predetermined multiple may be referred to as amplifying gain operation control. Semi-static amplifying gain operation control signaling of the NCR may be configured by higher layer signaling (e.g., RRC or MAC-CE). Hereinafter, higher layer signaling for amplifying gain operation control of the NCR is referred to as NCR-AGConfig for convenience of explanation. However, the names of the signaling are not limited to the terms described later in the disclosure, and other terms having equivalent technical meanings may be used. When the NCR-AGConfig is not configured, the NCR may operate by selecting the amplifying gain under the determination of the NCR based on a channel condition or in a random manner.

When the NCR receives semi-static amplifying gain operation control signaling from the BS, a value of the amplifying gain may be expected to be obtained by applying Equation (1), as follows.

AG_{f,q,d}=max(AGₘᵢₙ,min(AGₘₐₓAG_{cell}+AG_{NCR,f,q,d}))in dB (1)

In Equation (1), AG represents the amplifying gain in dB scale in a carrier f, a beam or RS index q, and a time division duplex (TDD) direction d. The carrier f refers to a contiguous band of a passband of the NCR, the beam or RS index q refers to the beam of the backhaul or access link of the NCR-Fwd or the RS associated with the QCL relationship applied to the backhaul or access link of the NCR, and the TDD direction refers to UL or DL. The passband refers to a frequency domain region in which the NCR-Fwd operates, and the NCR-Fwd may be configured with one or multiple passbands. Each passband corresponds to a range of contiguous frequency domain regions, and if discontinuous, frequency domain regions may be configured with different passbands, respectively.

AGₘᵢₙ and AGₘₐₓ represent the minimum and maximum amplifying gain of the NCR. Since the maximum and minimum amplifying gain that the NCR may have differs depending on the design of each NCR, the maximum and minimum amplifying gain may be included in a capability report transmitted by the NCR and reported to the BS. AG_{cell} is a cell-specific parameter and may be configured by higher layer signaling (e.g., RRC signaling). The range of AG_{cell} may be configured from AGₘᵢₙ to AG_{cell}, and when there is no separate configuration a configuration interval of AG_{cell} may be configured at 1 dB intervals (or predetermined intervals), and a specific dB unit corresponding to the configuration interval of AG_{cell} may be configured. When the capability report transmitted by the NCR includes the granularity (the unit of the interval) for the amplifying gain, the NCR may receive a configuration for the interval according to the reported granularity. AG_{NCR} is an NCR-specific parameter and may be configured with one or a combination of the following methods.

In Method 1, AG_{NCR} may be configured by higher layer signaling (e.g., RRC signaling). The range of AG_{NCR} may be configured from AGₘᵢₙ to AG_{cell}. When there is no separate configuration, the interval may be configured at 1 dB intervals (or predetermined intervals) as an example, and configuration of a specific dB unit corresponding to the configuration interval of AG_{NCR} is also possible. When the capability report transmitted by the NCR includes the granularity for the amplifying gain, the NCR may receive a configuration for the interval according to the reported granularity. RRC signaling for configuring AG_{NCR} may include one of information about a carrier to which the amplifying gain operation is applied, a beam or RS index, and a TDD direction. When the above information is not included in RRC signaling, application of a generally configured AG_{NCR} is also possible. For example, when information about a carrier is not included in RRC signaling, the NCR may apply configured amplifying gain parameters to all carriers of the NCR-Fwd.

In Method 2, AG_{NCR} may be configured with a combination of higher layer signaling, RRC signaling, and MAC-CE. As an example, referring to Table 16 as shown below, the BS may configure at least one of values 1, 2, 3, and 4 via RRC signaling. The configuration may be in the form of a list, for example. Thereafter, the BS may indicate at least one of the values configured for RRC signaling by using the MAC-CE. For example, a value of one of entries for multiple values (or lists) configured via RRC signaling may be indicated by bit(s) of the MAC CE. The MAC CE may indicate whether one of values 1 to 4 is applied, by using 2 bits. For example, 2 bits of “00” may indicate entry 0, and “01” may indicate entry 1. The NCR may obtain a value of the amplifying gain by referring to the RRC signaling and the MAC CE.

As shown below in Table 16, the number of entries to be configured is 4 as an example, but is not limited thereto, and up to X entries may be configured. The number of entries X will be determined according to the number of entry bits allocated to the MAC-CE. However, it is also possible that fewer values than the number of entries X are configured via RRC signaling. At least one of information about the carrier, the beam or RS index, and the TDD direction to which AG_{NCR} is to be applied may be indicated by being included in the MAC-CE or may be included in RRC signaling. For example, values 1, 2, 3, and 4 may include beam or RS index information for CSI-RS #0 to 4, respectively.

TABLE 16

| Entry by MAC-CE | Value |
|---|---|
| 0 | Value1 configured by RRC |
| 1 | Value2 configured by RRC |
| 2 | Value3 configured by RRC |
| 3 | Value4 configured by RRC |

When the parameter AG_{NCR} is configured with a value defined as an inapplicable value (e.g., -inf), the NCR may stop operation of signal amplification and forwarding of the NCR-Fwd in the corresponding carrier, beam or RS index, and TDD direction.

### SECOND EXAMPLE

### Dynamic Amplifying Gain Control for Network-Controlled Repeater

In the second example, a method in which an NCR dynamically receives signaling from a BS and controls an amplifying gain operation of an NCR-Fwd is described. According to the method of dynamically controlling the amplifying gain operation, faster power control is performed than that of the semi-static control method, and thus a good signal quality of the UE may be maintained when the UE experiences a rapidly changing channel The amplifying gain operation of the NCR-Fwd corresponds to an operation of amplifying the strength of a received signal by a predetermined multiple of the strength when the NCR performs an operation of amplifying and forwarding the signal. In this operation, configuring and instructing the predetermined multiple may be referred to as amplifying gain operation control.

Dynamic amplifying gain operation control signaling for the NCR may correspond to DCI-based SCI or a combination of higher layer signaling (e.g., RRC signaling) and DCI-based SCI.

When the NCR receives dynamic amplifying gain operation control signaling from a BS, a value of the amplifying gain may be obtained by applying Equation (2), as follows.

AG_{f,q,d}=max(AGₘᵢₙ,min(AGₘₐₓAG_{cell}+α_{f,q,d}))in dB (2)

In Equation (2), AG represents the amplifying gain in dB scale in a carrier f, a beam or RS index q, and a TDD direction d. The carrier f refers to a contiguous band of a passband of the NCR, the beam or RS index q refers to the beam of the backhaul or access link of the NCR-Fwd or the RS associated with the QCL relationship applied to the backhaul or access link of the NCR, and the TDD direction refers to UL or DL. The passband refers to a frequency domain region in which the NCR-Fwd operates, and the NCR-Fwd may be configured with one or multiple passbands. Each passband may correspond to a range of contiguous frequency domain regions, and if discontinuous, frequency domain regions may be configured with different passbands, respectively.

AGₘᵢₙ and AGₘₐₓ represent the minimum and maximum amplifying gain of the NCR. Since the maximum and minimum amplifying gain that the NCR may have differs depending on the design of each NCR, the maximum and minimum amplifying gain may be included in a capability report transmitted by the NCR and reported to the BS. AG_{cell} is a cell-specific parameter and may be configured by higher layer signaling (e.g., RRC signaling). The range of AG_{cell} may be configured from AGₘᵢₙ to AG_{cell}, and when there is no separate configuration a configuration interval of AG_{cell} may be configured at 1 dB intervals (or predetermined intervals), and a specific dB unit corresponding to the configuration interval of AG_{cell} may be configured. When the capability report transmitted by the NCR includes the granularity for the amplifying gain, the NCR may receive a configuration for the interval according to the reported granularity.

“α” is a parameter that may be dynamically instructed by the NCR from the BS via SCI, and may be indicated by one or a combination of the following methods.

In Method 3, α may be indicated by reinterpreting the existing TPC command field. The existing TPC command refers to a TPC command for scheduled PUSCH field (or TPC command for scheduled PUCCH field) in DCI format 0_0, 0_1, 0_2 for scheduling a PUSCH (or DCI format 1_0, 1_1, 1_2 for scheduling a PDSCH), and a TPC command field in each block of DCI format 2_2, 2_3. The NCR may detect a PDCCH through the NCR-MT and receive the existing TPC command field through DCI transmitted on the PDCCH.

The NCR-MT will be able to distinguish between whether the received TPC command field is information for power control to be used for PUSCH or PUCCH transmission or information for controlling amplifying gain operation used for the NCR-Fwd. For example, when the NCR detects DCI format 0_0, 0_1 or 0_2 (or DCI format 1_0, 1_1, 1_2) and specific conditions, such as NDI=0, RV=all “1”, HARQ process number=all “0”, FDRA type0, or type1=all “0”, in a field included in the detected DCI are satisfied, the NCR may know that the DCI is for controlling the amplifying gain operation, rather than scheduling the PUSCH (or PDSCH). Specific conditions are not limited to the above examples, and other conditions having equivalent technical meanings may be used. For example, in case that a field of another DCI format is configured as a predetermined value or a condition such as DCI is received using a specific RNTI is satisfied, the NCR may identify that the TPC command field included in the DCI is for controlling the amplifying gain operation of the NCR.

When the specific condition is satisfied, the NCR may obtain α by referring to the existing TCP command field table as shown below in Table 17, depending on whether the higher layer parameter TPC-accumulate is configured. Alternatively, when the NCR detects DCI formats 2_2 and 2_3, the NCR may identify which block included in the DCI is used for amplifying gain operation of the NCR by higher layer signaling. In addition, if TPC-accumulate is not configured (or enabled), the NCR may obtain α by summing the values corresponding to TPC commands from SCI including an Nth previous TPC command to SCI including a current TPC command. However, if the TPC-accumulate is configured (or disabled), the NCR may determine the value corresponding to the TPC command as α.

When the NCR detects DCI format 0_0, 0_1, 0_2 (or DCI format 1_0, 1_1, 1_2), the MCS field information may be reinterpreted as being mapped to each carrier such that each bit indicates each carrier. The NCR may identify a carrier to which α is applied, based on the MCS field. The NCR may identify the beam or RS index to which α is to be applied, by using beam or QCL information applied from a corresponding symbol that is after PUSCH preparation time (or PDSCH processing time) from the last symbol of the PDCCH including the DCI. The NCR will be able to reinterpret a frequency hopping field to identify whether a TDD direction to which α is applied has been indicated via uplink or downlink. When the NCR detects DCI for scheduling the PDSCH, the NCR may apply the amplifying gain to the downlink, and when DCI for scheduling PUSCH is detected, the NCR may apply the amplifying gain to the uplink. A method of reinterpreting an existing field included in the DCI and mapping the reinterpreted field to information on a carrier, a beam or RS index, and a TDD direction to which α is to be applied is not limited to the above example, and other fields having equivalent technical meanings may be used. However, when the NCR detects DCI formats 2_2 and 2_3, the NCR applies a value of the amplifying gain indicated to all the carriers, beams, RS indexes, and TDD directions.

TABLE 17

| TPC command | TPC-accumulate not | TPC-accumulate |
|---|---|---|
| field | provided | provided |
| 0 | −1 | −4 |
| 1 | 0 | −1 |
| 2 | 1 | 1 |
| 3 | 3 | 4 |

In Method 4, the BS may indicate α, to the NCR, via SCI based on DCI including a TPC command field so as to control the amplifying gain operation. The NCR may receive an indication of a TPC command field having at least 2 bits through SCI based on DCI. For example, the TPC command field may correspond to a mapping table shown below in Table 18, and NCR may obtain α differently according to a higher layer parameter TPC-accumulate. A value of the second column of Table 17 may be configured by a higher layer parameter or MAC-CE transmitted from the BS. The number of entries as shown below in Table 18 is 4, but may vary depending on the bit number of the TPC command field.

If TPC-accumulate is not configured (or enabled), the NCR may obtain α by summing the values corresponding to the TPC commands from SCI including an Nth previous TPC command to SCI including a current TPC command. The parameter N may be configured by higher layer signaling. However, when TPC-accumulate is configured (or disabled), the NCR may determine the value corresponding to the TPC command as α.

At least one of the carrier, beam or RS index, and a TDD direction information may be included in the SCI. Information not included in the SCI may be preconfigured through RRC signaling. When the corresponding information does not exist, the NCR may apply α information. For example, when beam or RS index information does not exist, the NCR may apply a value of the amplifying gain to all beams based on the TPC command.

TABLE 18

| TPC command | TPC-accumulate not | |
|---|---|---|
| field | provided | TPC-accumulate provided |
| 0 | −1 | Value1 configured by RRC/MAC-CE |
| 1 | 0 | Value2 configured by RRC/MAC-CE |
| 2 | 1 | Value3 configured by RRC/MAC-CE |
| 3 | 3 | Value4 configured by RRC/MAC-CE |

When the parameter α is configured with a value defined as an inapplicable value (e.g., -inf), the NCR may end the signal amplification and forwarding operation of the NCR-Fwd in the corresponding carrier, beam or RS index, and TDD direction.

### THIRD EXAMPLE

### Time Axis Control for Amplifying Gain Operation of Network-Controlled Repeater

In the third example, a time-based control method is described when the NCR semi-statically or dynamically receives signaling from a BS and controls the operation for the amplifying gain of the NCR-Fwd. When the signal amplifying gain for the NCR is too large, the performance of the entire system will decrease. However, the coverage of the NCR will decrease when the amplifying gain is excessively reduced due to the disadvantage of the NCR that amplifies noise. Thus, an operation of excessively increasing or decreasing the signal amplifying gain of the NCR is burdensome to the entire system. Therefore, the BS needs to perform a conservative operation of configuring the signal amplifying gain of the NCR as a value that can reduce the influence of interference on neighboring cells under normal circumstances and increasing the signal amplifying gain as necessary. In addition, the NCR needs to reconfigure the amplifying gain to a default value after a predetermined period of time has elapsed in order to reduce the number of times the BS performs signaling for controlling the amplifying gain operation for the NCR.

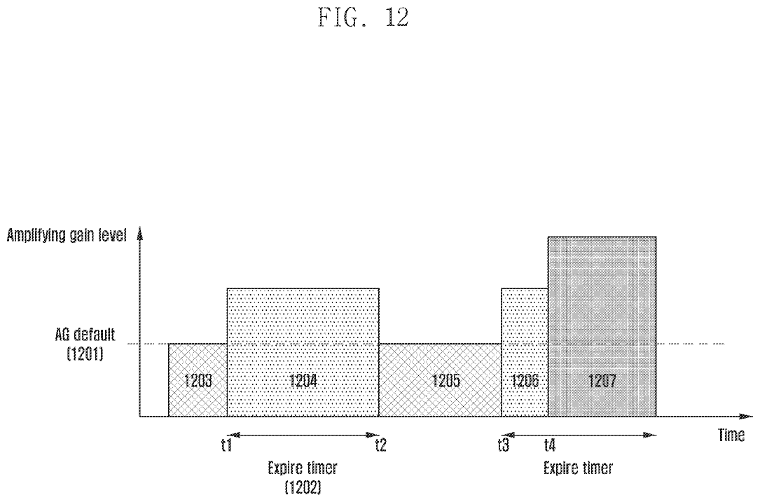

FIG. 12 illustrates an example of an amplifying gain for an NCR on a time axis according to an embodiment.

Referring to FIG. 12, a default amplifying gain (AG) 1201 is configured in the NCR, and the amplifying gain has been increased by semi-static or dynamic signaling at time t1. In an amplifying gain 1204, the power of a received signal is further amplified beyond that of an amplifying gain 1203. When an expire timer 1202 is configured and thus the amplifying gain is changed, the amplifying gain of the NCR automatically returns to the default amplifying gain at time t2 at which the value of the timer decreases by 1 in symbol or slot units or time units (for example, ms) and becomes 0. At time t3, the amplifying gain is increased again by semi-static or dynamic signaling (indicated by reference numeral 1206), and the amplifying gain is re-increased by signaling at time t4 (indicated by reference numeral 1207). The expire timer may start at a time when signaling for amplifying gain control is received or at a time when amplifying gain control is expected to be applied.

As described in the first and second examples, the NCR may be instructed or configured with signaling including at least one of RRC signaling, MAC-CE, and SCI, to perform semi-static or dynamic amplifying gain control. An amplifying gain change time after the NCR receives the RRC or MAC-CE may be expected to be applied after 3 ms after transmitting a PUCCH including HARQ-ACK information of a PDSCH having RRC signaling or MAC-CE included therein. In addition, in method 4, the amplifying gain change time after the NCR receives a PDCCH including SCI may correspond to a time after the PUSCH preparation time or PDSCH processing time after the last symbol of the PDCCH including DCI. Further in method 4, the amplifying gain change time may correspond to a time after the PDSCH processing time after the last symbol of the PDCCH including SCI or a time after a time configured by higher layer signaling.

As shown in FIG. 12, the NCR may receive a configuration of the default amplifying gain and expire timer via higher layer signaling (e.g., RRC signaling or MAC CE). When the default amplifying gain and/or expire timer is not configured, the NCR may configure the default amplifying gain and/or expire time value as a random value or a predetermined value. When, as in time t3, the NCR receives signaling for configuring a new value of the amplifying gain while the expire timer is running, the NCR may operate in one or a combination of the following operations.

In Method 5, when the NCR receives new amplifying gain configuration information for the same carrier, beam or RS index, and a TDD direction as that of the previously changed amplifying gain, the NCR disregards the expire timer that started at the time of the previous amplifying gain change, and applies a new expire timer value according to newly received amplifying gain configuration information.

In Method 6, when the NCR receives new amplifying gain configuration information for the same carrier, beam or RS index, and a TDD direction as that of the previously changed amplifying gain, the NRC applies the default amplifying gain as the amplifying gain when the expire timer that started at the time of the previous amplifying gain change has a value of 0. That is, new amplifying gain configuration information received while the expire timer is running may be disregarded.

The above method has been described as an example in which an object to which the amplifying gain information related to the expire timer being running is applied (defined by a carrier, a beam or RS index, a TDD direction) and an object from which new amplifying gain configuration information is received are identical. Alternatively, the above method may be applied to a case in which an object to which the amplifying gain information related to the expire timer being running is applied and an object from which new amplifying gain configuration information is received correspond to the same carrier or the same beam or even when at least one of the carrier, beam or RS index, and TDD direction is the same.

The NCR may be configured or instructed to apply different amplifying gains to multiple beams. For example, when the NCR changes beam 1 for signal transmission and reception (transmission or reception) to beam 2 before a value of expire timer becomes 0, the expire timer for beam 1 before change may follow one of the following operations or a combination thereof.

In Method 7, the expire timer of beam 1 stops until beam 1 is re-applied to the signal transmission and reception of the NCR. That is, in case that the NCR applies beam 1, the expire timer applies a previous value. When the NCR re-applies beam 1, a time of the expire timer is remaining, and thus the NCR may maintain the increased amplifying gain value for beam 1.

In Method 8, the expire timer of beam 1 continues to decrease regardless of whether beam 1 is applied. For example, in case that the NCR receives amplifying gain information for beam 1 while performing signal transmission and reception by applying beam 1 and running of the expire timer is started, even when the NCR applies beam 2, running of the expire timer does not stop. When a value of the expire timer becomes 0 while applying beam 2, the NCR applies the default amplifying gain value for beam 1 even if the NCR re-applies beam 1. In case that the NCR re-applies beam 1, when there is a time left in the expire timer, the NCR may maintain the increased amplifying gain value for beam 1.

When the NCR receives inapplicable value configured as the default amplifying gain, the NCR stops the amplifying and forwarding operation of the NCR-Fwd until an applicable value is configured or instructed. Thereafter, in case that the NCR receives configuration or instruction of the amplifying gain operation including the applicable value, the amplifying and forwarding operation of the NCR-Fwd may be performed during running of the expire timer.

Alternatively, the configuration information related to the amplifying gain described in the first example or the second example may include a timer value. In this case, a combination of at least one of methods 1 to 8 described above may be applied.

At least one of the above-described examples may be used in combination with each other, and the above-described examples may be modified and applied under the clear understanding of those skilled in the art. In case that the amplifying gain is controlled as an example or according to the first example or the second example, the expire timer and the default amplifying gain according to the third example may also be applied together.

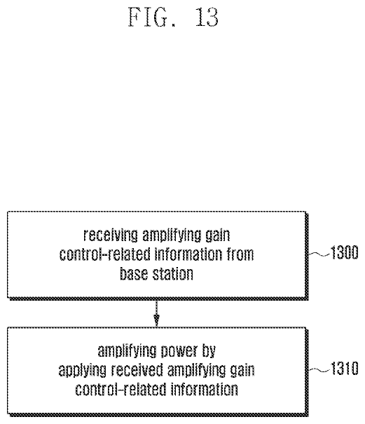

FIG. 13 shows an example of a method for controlling amplifying gain of an NCR according to an embodiment.

In FIG. 13, in step 1300, the NCR may receive information related to amplifying gain control from a BS. The information related to the amplifying gain control may be signaling for the above-described semi-static amplifying gain control and/or signaling for the above-described dynamic amplifying gain control. The detailed signaling may follow the first or second example described above. Before receiving the information related to the amplifying gain control, the NCR may transmit capability information related to the amplifying gain control to the BS.

In step 1310, upon receiving the information related to amplifying gain control, the NCR controls the amplifying gain of the signal according to the information. A detailed amplifying gain control method may follow at least one of the first to third examples.

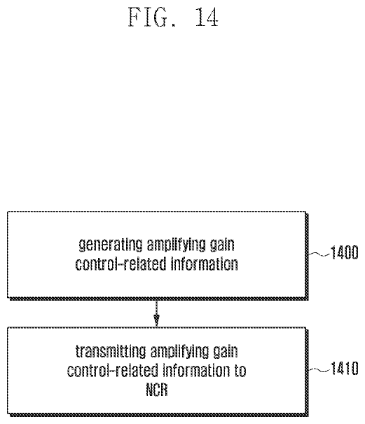

FIG. 14 illustrates an example of a method for controlling amplifying gain of an NCR of a BS according to an embodiment.

In FIG. 14, in step 1400, the BS generates information related to amplifying gain control to be transmitted to the NCR. The BS my determine the amplifying gain to be applied to the NCR by considering a channel state, the coverage of the BS, the number of NCRs and/or UEs for providing service, and the interference impact on neighboring cells by the NCR, etc., and may generate the information related to amplifying gain control to indicate the determined amplifying gain. The information related to the amplifying gain control may be signaling for the above-described semi-static amplifying gain control and/or signaling for the above-described dynamic amplifying gain control. The detailed signaling may follow the first or second example described above. In addition, the BS may receive capability information related to amplifying gain control from the NCR, and may generate the information related to amplifying gain control based on the received capability information.

In step 1410, the BS may transmit the information related to amplifying gain control to the NCR. Upon receiving the information related to amplifying gain control, the NCR may control the amplifying gain of the signal according to the information.

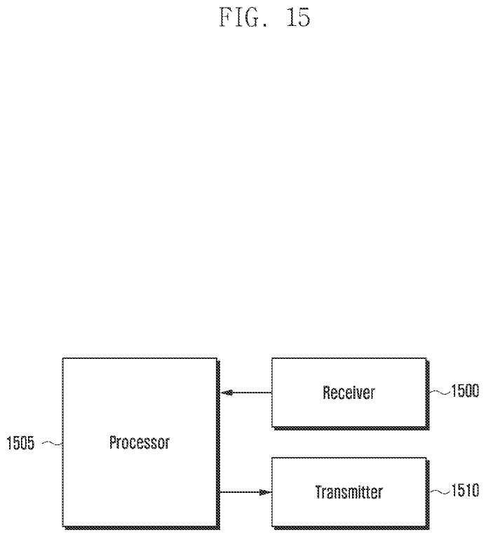

FIG. 15 illustrates the structure of a UE in a wireless communication system according to an embodiment.

Referring to FIG. 15, the UE may include a receiver 1500, a transmitter 1510, and a processor 1505.

For example, since the NCR relaying between a UE and a BS as described above appears as a UE from the point of view of the BS, in this case, the UE of FIG. 13 may be the NCR. For example, the NCR may include a receiver, a transmitter, and a processor (a controller).

The receiver 1500 and the transmitter 1510 may be collectively referred to as a transceiver. According to the communication method of the UE described above, the receiver 1500, the transmitter 1510, and the processor 1505 of the UE may operate. However, the elements of the UE are not limited to the above-described examples. For example, the UE may include more or fewer elements than the aforementioned elements (e.g., a memory). In addition, the receiver 1500, UE transmitter 1510, and the processor 1505 may be implemented in the form of a single chip.

The receiver 1500 and the transmitter 1510 (or, a transceiver) may transmit/receive a signal to/from a BS. The signal may include control information and data. To this end, the transceiver may include an RF transmitter configured to up-convert and amplify the frequency of a transmitted signal, and an RF receiver configured to perform low-noise amplification of a received signal and down-convert the frequency thereof. However, this is only an example, and elements of the transceiver are not limited to the RF transmitter and the RF receiver.

In addition, the transceiver may receive a signal through a wireless channel, output the signal to the processor 1505, and transmit a signal output from the processor 1505 through the wireless channel.

The memory may store programs and data required for operation of the UE. In addition, the memory may store control information or data included in signals acquired by the UE. The memory may include a storage medium such as a read only memory (ROM), a random access memory (RAM), a hard disk, a compact disc (CD)-ROM, and a digital versatile disc (DVD), or a combination of storage media.

In addition, the processor 1505 may control a series of processes so that the UE may operate according to the above-described embodiment. The processor 1505 may be implemented as a controller or one or more processors.

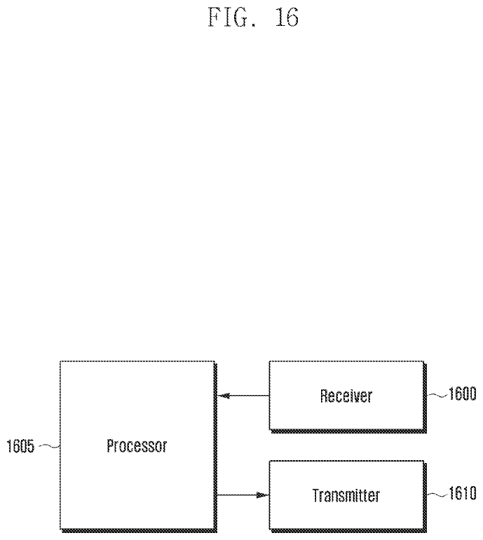

FIG. 16 illustrates the structure of a BS in a wireless communication system according to an embodiment.

Referring to FIG. 16, the BS may include a receiver 1600, a transmitter 1610, and a processor (controller) 1605.

For example, since the NCR relaying between a BS and a BS as described above appears as a BS from the point of view of the UE, in this case, the BS of FIG. 16 may be the NCR. For example, the NCR may include a receiver, a transmitter, and a processor (a controller).

The receiver 1600 and the transmitter 1610 may be collectively referred to as a transceiver. According to the communication method of the BS described above, the receiver 1600, the transmitter 1610, and the processor 1605 of the BS may operate. However, the elements of the BS are not limited to the above-described examples. For example, the BS may include more or fewer elements than the aforementioned elements (e.g., a memory). In addition, the receiver 1600, the transmitter 1610, and the processor 1605 may be implemented in the form of a single chip.

The receiver 1600 and the transmitter 1610 (or, a transceiver) may transmit/receive a signal to/from a UE. The signal may include control information and data. To this end, the transceiver may include an RF transmitter configured to up-convert and amplify the frequency of a transmitted signal, and an RF receiver configured to perform low-noise amplification of a received signal and down-convert the frequency thereof. However, this is only an example, and elements of the transceiver are not limited to the RF transmitter and the RF receiver.

In addition, the transceiver may receive a signal through a wireless channel, output the signal to the processor 1605, and transmit a signal output from the processor 1605 through the wireless channel.

The memory may store programs and data required for operation of the BS. In addition, the memory may store control information or data included in signals acquired by the BS. The memory may include a storage medium such as a ROM, a RAM, a hard disk, a CD-ROM, and a DVD, or a combination of storage media.

The processor 1605 may control a series of processes so that the BS operates according to the above-described embodiment. The processor 1605 may be implemented as a controller or one or more processors.

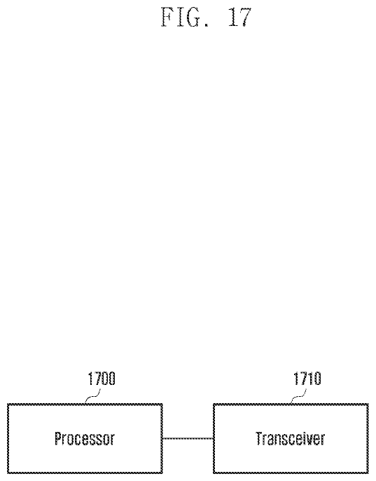

FIG. 17 illustrates the structure of an NCR in a wireless communication system according to an embodiment.

Referring to FIG. 17, the NCR may include a processor (controller) 1700 and a transceiver 1710, which may operate according to the communication methods of the NCR described above. Specifically, the processor 1700 and the transceiver 1710 may perform the operations of NCR-MT and NCR-fwd described above. However, the elements of the NCR are not limited to the above-described examples. For example, the NCR may include more or fewer elements than the aforementioned elements (e.g., a memory). In addition, the processor 1700 and the transceiver 1710 may be implemented in the form of a single chip.

The transceiver 1710 may transmit/receive a signal to/from a BS and a UE. Here, the signal may include control information and data. For example, the transceiver 1710 may receive control information and downlink signals for controlling the operation of the NCR from the BS, and amplify and transmit uplink signals of the UE to the BS. The transceiver 1710 may transmit feedback information and/or SRS about signaling of the BS, and may receive uplink signals from the UE and amplify and transmit downlink signals of the BS to the UE. To this end, the transceiver 1710 may include an RF transmitter configured to up-convert and amplify the frequency of a transmitted signal, and an RF receiver configured to perform low-noise amplification of a received signal and down-convert the frequency thereof. However, this is only an example, and elements of the transceiver 1710 are not limited to the RF transmitter and the RF receiver.

The memory may store programs and data required for operation of the BS. In addition, the memory may store control information or data included in signals acquired by the BS. The memory may include a storage medium such as a ROM, a RAM, a hard disk, a CD-ROM, and a DVD, or a combination of storage media.

The processor 1700 may control a series of processes so that the NCR operates according to the above-described embodiment. The processor 1700 may be implemented as a controller or one or more processors.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). In some alternative implementations, the functions noted in the blocks may occur out of order. For example, two blocks shown in succession may in fact be executed substantially concurrently or the blocks may sometimes be executed in the reverse order, depending upon the functionality involved.

While the disclosure has been particularly shown and described with reference to certain embodiments thereof, it will be understood by those skilled in the art that various changes in form and details may be made therein without departing from the scope of the subject matter as defined by the appended claims and their equivalents.

What is claimed is:

1. A method performed by a network-controlled repeater (NCR) in a communication system, the method comprising:
receiving, from a base station (BS), configuration information on an amplifying gain for the NCR;
identifying the amplifying gain based on the configuration information;
amplifying signals received from a terminal and the BS based on the identified amplifying gain; and
transmitting the amplified signals.

2. The method of claim 1,
wherein the configuration information includes an amplifying gain value and information associated with the amplifying gain, and
wherein the information associated with the amplifying gain includes at least one of a passband, a beam or reference signal index, or a time domain division (TDD) direction associated with the amplifying gain.

3. The method of claim 1, further comprising:
receiving, from the BS, a medium access control (MAC) control element (CE) including an indicator indicating an amplifying gain value among a plurality of amplifying gain values included in the configuration information,
wherein the identified amplifying gain is based on the MAC CE and the configuration information.

4. The method of claim 1, further comprising:
transmitting, to the BS, capability information associated with the amplifying gain,
wherein the capability information includes an interval for configuring an amplifying gain value.

5. A method performed by a base station (BS) in a communication system, the method comprising:
transmitting, to a network-controlled repeater (NCR), configuration information on an amplifying gain for the NCR,
wherein the amplifying gain is based on the configuration information, and
wherein amplified signals from the NCR are based on the amplifying gain.

6. The method of claim 5,
wherein the configuration information includes a value of the amplifying gain and information associated with the amplifying gain, and
wherein the information associated with the amplifying gain includes at least one of a passband, a beam or reference signal index, or a time domain division (TDD) direction associated with the amplifying gain.

7. The method of claim 5, further comprising:
transmitting, to the NCR, a medium access control (MAC) control element (CE) including an indicator indicating an amplifying gain value among a plurality of amplifying gain values included in the configuration information,
wherein the amplifying gain is based on the MAC CE and the configuration information.

8. The method of claim 5, further comprising:
receiving, from the NCR, capability information associated with the amplifying gain,
wherein the capability information includes an interval for configuring an amplifying gain value.

9. A network-controlled repeater (NCR) in a communication system, the NCR comprising:
a transceiver; and
a controller coupled with the transceiver and configured to:
receive, from a base station (BS), configuration information on an amplifying gain for the NCR,
identify the amplifying gain based on the configuration information,
amplify signals received from a terminal and the BS based on the identified amplifying gain, and
transmit the amplified signals.

10. The NCR of claim 9,
wherein the configuration information includes an amplifying gain value and information associated with the amplifying gain, and
wherein the information associated with the amplifying gain includes at least one of a passband, a beam or reference signal index, or a time domain division (TDD) direction associated with the amplifying gain.

11. The NCR of claim 9,
wherein the controller is further configured to receive, from the BS, a medium access control (MAC) control element (CE) including an indicator indicating an amplifying gain value among a plurality of amplifying gain values included in the configuration information, and
wherein the identified amplifying gain is based on the MAC CE and the configuration information.

12. The NCR of claim 9,
wherein the controller is further configured to transmit, to the BS, capability information associated with the amplifying gain, and
wherein the capability information includes an interval for configuring an amplifying gain value.

13. A base station (BS) in a communication system, the BS comprising:
a transceiver; and
a controller coupled with the transceiver and configured to:
transmit, to a network-controlled repeater (NCR), configuration information on an amplifying gain for the NCR,
wherein the amplifying gain is based on the configuration information, and
wherein amplified signals from the NCR are based on the amplifying gain.

14. The BS of claim 13,
wherein the configuration information includes an amplifying gain value and information associated with the amplifying gain, and
wherein the information associated with the amplifying gain includes at least one of a passband, a beam or reference signal index, or a time domain division (TDD) direction associated with the amplifying gain.

15. The BS of claim 13,
wherein the controller is further configured to transmit, to the NCR, a medium access control (MAC) control element (CE) including an indicator indicating an amplifying gain value among a plurality of amplifying gain values included in the configuration information, and
wherein the amplifying gain is based on the MAC CE and the configuration information.
